(19) United States
(12) Patent Application Publication
(10) Pub. No.: US 2018/0217557 A1
(43) Pub. Date: Aug. 2, 2018

(54) ELECTRONIC TIMEPIECE

(71) Applicant: Seiko Epson Corporation, Tokyo (JP)

(72) Inventor: Chisato TEZUKA, Okaya (JP)

(21) Appl. No.: 15/874,427

(22) Filed: Jan. 18, 2018

(30) Foreign Application Priority Data
Jan. 27, 2017 (JP) 2017-013531

(51) Int. Cl. G04B 19/22; G04B 19/04; G04R 20/02

(52) U.S. Cl. CPC G04B 19/22; G04R 20/02; G04B 19/04

(57) ABSTRACT

An electronic timepiece enabling easily changing the time zone is provided. The electronic timepiece includes: an operating means; memory configured to store information related to multiple time zone data indicating a time difference to a reference time, and information related to the set time zone data selected from the multiple time zone data; a time display unit having at least an hour hand and a minute hand, and configured to display time; and a controller configured to execute a time zone correction mode to correct the information related to the time zone data that is set. The controller moves the hour hand and displays time on the time display unit in response to operation of the operating means in the time zone correction mode, and based on time zone data corresponding to the displayed time, corrects information related to the set time zone data.

### BACKGROUND

### 1. Technical Field

The invention relates to an electronic timepiece that enables manually changing the time zone of the displayed time.

### 2. Related Art

Electronic timepieces that enable the user to manually select the time zone and change the displayed time are known from the literature. See, for example, JP-A-2016-166786.

The electronic timepiece described in claim JP-A-2016-166786 has city names indicating time zones, and time difference information indicating the time difference to Coordinated Universal Time (UTC), displayed on the bezel, for example. When the time zone setting mode is selected by a user operation, the second hand points to the city name or time difference marker corresponding to the currently set time zone. When the user then performs an operation changing the time zone by manipulating the crown or a button, for example, the second hand moves to indicate the selected time zone. As a result, the user of the timepiece can set the time zone by checking the city name or time difference indicated by the second hand.

On a small timepiece, however, the characters indicating the city name or time difference on the dial, bezel, or other case member are also small and can be difficult to read. The city names representing the time zones are typically abbreviated to three English letters, and it can be difficult for the user to intuitively understand the region to which the time zone applies.

It can therefore be difficult for the user to appropriately select and change the time zone setting.

### SUMMARY

An electronic timepiece according to the invention enables easily changing the time zone.

An electronic timepiece according to the invention has an operating means; memory configured to store information related to multiple time zone data indicating a time difference to a reference time, and information related to the set time zone data selected from the multiple time zone data; a time display unit having at least an hour hand and a minute hand, and configured to display time; and a controller configured to execute a time zone correction mode to correct the information related to the time zone data that is set. The controller moves the hour hand and displays time on the time display unit in response to operation of the operating means in the time zone correction mode, and based on time zone data corresponding to the displayed time, corrects information related to the set time zone data.

In the time zone correction mode in this aspect of the invention, the crown, button, or other operating means can directly move the hour hand, and correct the set time zone data based on the time zone data corresponding to the time displayed after the hour hand moves. As a result, if the user knows the local time or the time difference in the current location, the user can easily change the time zone data even without knowing the time zone of the current location by directly moving the hour hand.

Furthermore, because the hour hand only needs to be directly moved commensurately to the time difference, the user can intuitively and quickly correct the time difference.

In addition, because city names and time difference markers indicating the time zone are not displayed on the case of the electronic timepiece, the invention can also be used in small timepieces, such as a ladies' wristwatch, and timepiece design can be improved.

An electronic timepiece according to another aspect of the invention has: an operating means; memory configured to store information related to multiple time zone data indicating a time difference to a reference time, and information related to the set time zone data selected from the multiple time zone data; a time display unit having at least an hour hand and a minute hand, and configured to display time; and a controller configured to execute a time zone correction mode to correct the information related to the time zone data that is set. In the time zone correction mode, the controller selects and executes an hour hand setting mode that moves the hour hand, and a minute hand setting mode that moves the minute hand; moves the hour hand and displays time on the time display unit in response to operation of the operating means in the hour hand setting mode, moves the minute hand and displays time on the time display unit in response to operation of the operating means in the minute hand setting mode, and based on time zone data corresponding to the displayed time, corrects information related to the set time zone data.

The time zone correction mode in this aspect of the invention includes an hour hand setting mode that moves the hour hand, and a minute hand setting mode that moves the minute hand, and can correct the set time zone data based on the time zone data corresponding to the time displayed after the hour hand and minute hand are moved. As a result, if the user knows the local time or the time difference in the current location, the user can easily change the time zone data by directly moving the hour hand and minute hand even without knowing the time zone of the current location.

Furthermore, because the hour hand and minute hand only need to be directly moved commensurately by the time difference, the user can intuitively and quickly correct the time difference. Furthermore, because the hour hand can be moved alone, the time zone data can be quickly corrected when there is no need to move the minute hand.

Furthermore, because the minute hand can be moved in addition to the hour hand, time zones that require correcting the minute can also be set, and the time can be displayed more accurately.

In addition, because city names and time difference markers indicating the time zone are not displayed on the case of the electronic timepiece, the invention can also be used in small timepieces, such as a ladies' wristwatch, and timepiece design can be improved.

An electronic timepiece according to another aspect of the invention has: an operating means; memory configured to store information related to multiple time zone data indicating a time difference to a reference time, and information related to the set time zone data selected from the multiple time zone data; a time display unit having at least an hour hand and a minute hand, and configured to display time; and a controller configured to execute a time zone correction mode to correct the information related to the time zone data that is set. In response to operation of the operating means in the time zone correction mode, the controller moves the hour hand and the minute hand, and displays time on the time display unit, and based on time zone data corresponding to the displayed time, corrects information related to the set time zone data.

In the time zone correction mode in this aspect of the invention, the crown, button, or other operating means can directly move the hour hand and the minute hand, and correct the set time zone data based on the time zone data corresponding to the time displayed after the hour hand and the minute hand move. As a result, if the user knows the local time or the time difference in the current location, the user can easily change the time zone data even without knowing the time zone of the current location by directly moving the hour hand and the minute hand.

Furthermore, because the hour hand and minute hand only need to be directly moved commensurately by the time difference, the user can intuitively and quickly correct the time difference.

Furthermore, because the minute hand can be moved in addition to the hour hand, time zones that require correcting the minute can also be set, and the time can be displayed more accurately.

In addition, because city names and time difference markers indicating the time zone are not displayed on the case of the electronic timepiece, the invention can also be used in small timepieces, such as a ladies' wristwatch, and timepiece design can be improved.

In an electronic timepiece according to another aspect of the invention, in response to operation of the operating means in the minute hand setting mode, the controller moving the minute hand to a position that can be set based on time zone data that can be selected according to the position of the hour hand.

This aspect of the invention can appropriately set the display position of the minute hand based on the position of the hour hand, minimize the number of operations performed in the minute hand setting mode, and can quickly correct the time zone data.

In an electronic timepiece according to another aspect of the invention, in response to operation of the operating means, the controller moving the hour hand to a position that can be set based on the multiple time zone data; and a specific time after operation of the operating means, moving the minute hand to a position that can be set based on the multiple time zone data.

When the hour hand and minute hand are moved in this aspect of the invention, and the operating means is operated continuously multiple times, time zone data that requires, and time zone data that does not require, moving the minute hand may be sequentially selected. In this case, if time zone data that does not require moving the minute hand is selected before movement of the minute hand ends, the minute hand will have moved unnecessarily. By delaying moving the minute hand, this aspect of the invention can suppress unnecessary movement of the minute hand.

An electronic timepiece according to another aspect of the invention also has an hour hand motor that drives the hour hand; and a minute hand motor that drives the minute hand.

Because the hour hand and minute hand can be moved independently in this aspect of the invention, movement of the hour hand and minute hand can be minimized, and the time zone can be corrected more quickly than a configuration that drives the hour hand and minute hand by a single motor.

An electronic timepiece according to another aspect of the invention preferably also has a receiver configured to radio signals; the controller correcting information related to the time zone data based on the received radio signals.

An electronic timepiece according to this aspect of the invention can correct the time zone data by receiving signals or in response to operation of the operating means. As a result, the time zone data can be corrected based on signal reception in an environment where appropriate signals can be received, can correct the time zone data in response to operation of the operating means in an environment where signals cannot be received, such as while on an airplane, and user convenience can be improved.

In an electronic timepiece according to another aspect of the invention, when the time zone with the greatest difference ahead of Coordinated Universal Time is a first time zone, and the time zone with the greatest difference behind Coordinated Universal Time is a second time zone, the controller continues displaying the time corresponding to the first time zone when the operation advancing the time is performed by operating the operating means after the time corresponding to the first time zone is displayed, and the controller continues displaying the time corresponding to the second time zone when the operation reversing the time is performed by operating the operating means after the time corresponding to the second time zone is displayed.

In locations where the time is ahead of UTC, the maximum time difference to UTC is in the first time zone, which is UTC+14 hours, and in locations that are behind UTC, the maximum time difference to UTC is in the second time zone, which is UTC−12 hours. Therefore, if the operation advancing the time is performed after the time corresponding to UTC+14 hours is displayed, the operation advancing the time is performed again, and the time is changed to UTC−12 hours, the time may change as not intended by the user, thus confusing the user.

This aspect of the invention therefore continues displaying the time of the first time zone or the second time zone, enabling the user to easily know the time zone data setting, and thus preventing confusion.

In an electronic timepiece according to another aspect of the invention, when the time zone with the greatest difference ahead of Coordinated Universal Time is a first time zone, and the time zone with the greatest difference behind Coordinated Universal Time is a second time zone, the controller displays the time corresponding to the second time zone when the operation advancing the time is performed by operating the operating means after the time corresponding to the first time zone is displayed, and the controller displays the time corresponding to the first time zone when the operation advancing the time is performed by operating the operating means after the time corresponding to the second time zone is displayed.

If the user mistakes the operations advancing and reversing the time, and repeats the operation advancing the time after the time corresponding to UTC+14 hours is displayed, the time corresponding to UTC−12 hours can be set. As a result, operation in the same direction can display the time corresponding to all time zone data, and setting the time zone can continue without interrupting operation.

In an electronic timepiece according to another aspect of the invention, the controller also has a first jump function that changes the set time zone to +12 hours without moving the hour hand when a predetermined first jump operation is performed by the operating means; and has a second jump function that changes the set time zone to −12 hours without moving the hour hand when a predetermined second jump operation is performed by the operating means.

When the time difference is corrected ±12 hours in this aspect of the invention, the time zone can be changed without the hour hand turning a full revolution, and the time can be quickly corrected.

In an electronic timepiece according to another aspect of the invention, the time display unit has a secondhand; and the controller indicates with the second hand whether the time indicated by the hour hand is ante meridiem or post meridiem while the displayed time is being corrected by the operating means.

By indicating with the second hand whether the displayed time is morning or afternoon while moving the hour hand directly, the user can correctly know by reading the second hand whether the time is AM or PM, and can easily set the correct time zone data.

In an electronic timepiece according to another aspect of the invention, the time display unit has a date wheel; and the controller indicates with the date wheel whether the time indicated by the hour hand is ante meridiem or post meridiem while the displayed time is being corrected by the operating means.

By indicating with the date wheel whether the displayed time is morning or afternoon while moving the hour hand directly, the user can correctly know by reading the second hand whether the time is AM or PM, and can easily set the correct time zone data.

In an electronic timepiece according to another aspect of the invention, the time display unit has a second hand. When a display daylight saving time setting operation that displays the daylight saving time mode setting is performed by the operating means, the controller indicates with the second hand whether the daylight saving time mode is on to display daylight saving time, or is off to not display daylight saving time; and when the daylight saving time mode setting is displayed, and an operation changing the daylight saving time mode setting is performed by the operating means, the controller changes the current state of the daylight saving time mode setting from off to on or on to off.

Because this aspect of the invention can indicate by the second hand whether or not the daylight saving time mode is set, the user can easily know if the daylight saving time mode must be set, and can set the time difference appropriately. The daylight saving time mode can also be turned on and off easily by manipulating the operating means.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of an electronic timepiece according to a first embodiment of the invention.

FIG. 2 is a section view of an electronic timepiece according to the first embodiment of the invention.

FIG. 3 is a plan view of the movement of an electronic timepiece according to the first embodiment of the invention.

FIG. 4 is a block diagram of the circuit design of an electronic timepiece according to the first embodiment of the invention.

FIG. 5 is a block diagram of the data structure of memory in the first embodiment of the invention.

FIG. 6 is a table of manual time zone setting data in the first embodiment of the invention.

FIG. 7 is a flow chart of the time zone setting process in the first embodiment of the invention.

FIG. 8 illustrates changing the time zone in the first embodiment of the invention.

FIG. 9 is a table of manual time zone setting data in the second embodiment of the invention.

FIG. 10 is a flow chart of the time zone setting process in the second embodiment of the invention.

FIG. 11 is a flow chart of the time zone selection process in the second embodiment of the invention.

FIG. 12 illustrates setting a time zone that changes only the minute in the second embodiment of the invention.

FIG. 13 illustrates setting a time zone that changes the hour and the minute in the second embodiment of the invention.

FIG. 14 illustrates another example of setting a time zone that changes the hour and the minute in the second embodiment of the invention.

FIG. 15 is a flow chart of the time zone setting process in a third embodiment of the invention.

FIG. 16 illustrates changing the time zone in the third embodiment of the invention.

FIG. 17 illustrates changing the time zone in another embodiment of the invention.

FIG. 18 is a plan view of an electronic timepiece according to another embodiment of the invention.

FIG. 19 describes the display mechanism of an electronic timepiece according to another embodiment of the invention.

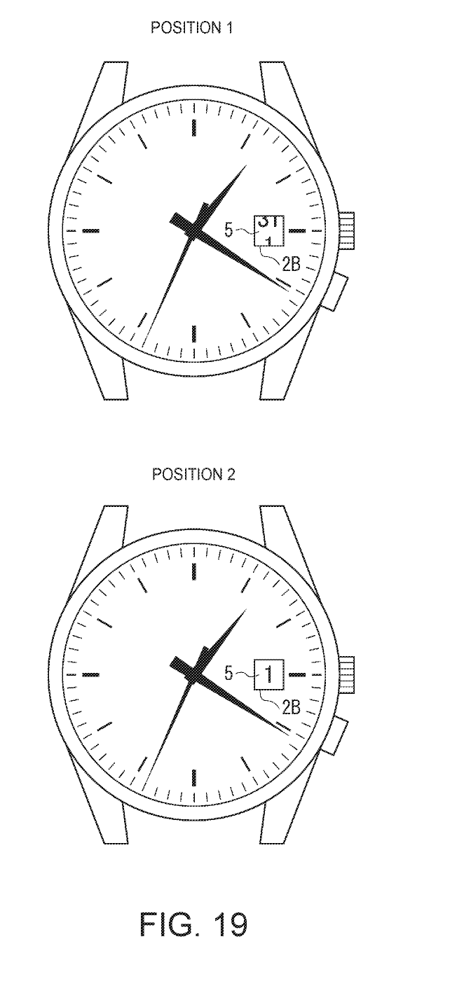

FIG. 20 is a plan view of an electronic timepiece according to another embodiment of the invention.

### DESCRIPTION OF EMBODIMENTS

### Embodiment 1

A first embodiment of the invention is described below with reference to the accompanying figures. Note that the crystal 31 side of the electronic timepiece 1 according to this embodiment is also referred to as the face, front, or top side, and the back cover 12 side is also referred to as the back or bottom side of the electronic timepiece 1.

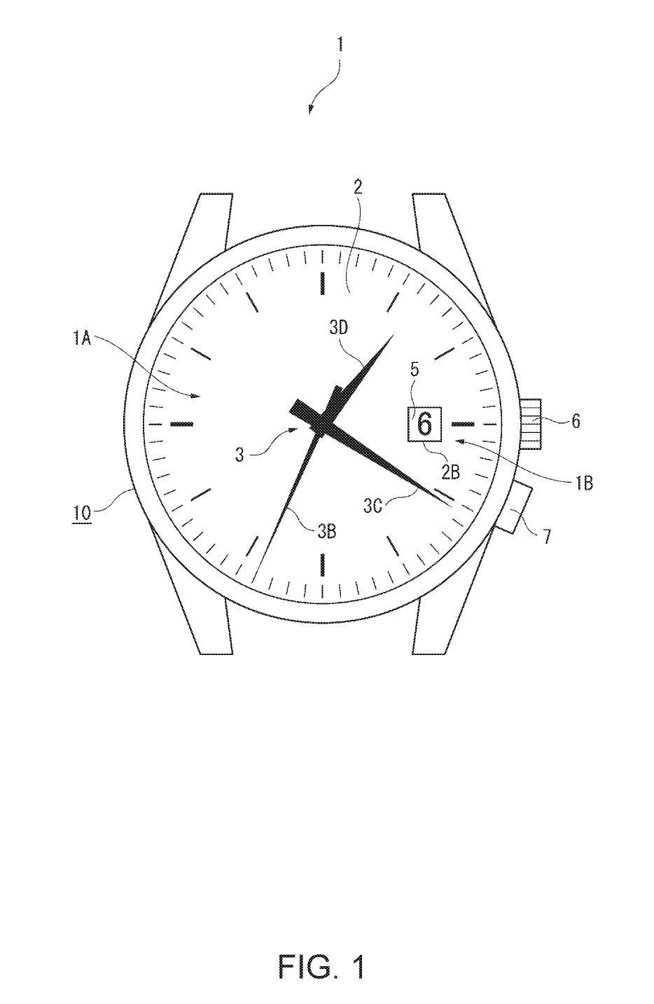

As shown in FIG. 1, the electronic timepiece 1 is a wristwatch with a time display unit 1A for displaying the time using a dial 2 and hands 3, and a calendar display unit 1B including a window 2B in the dial 2 and a date wheel 5.

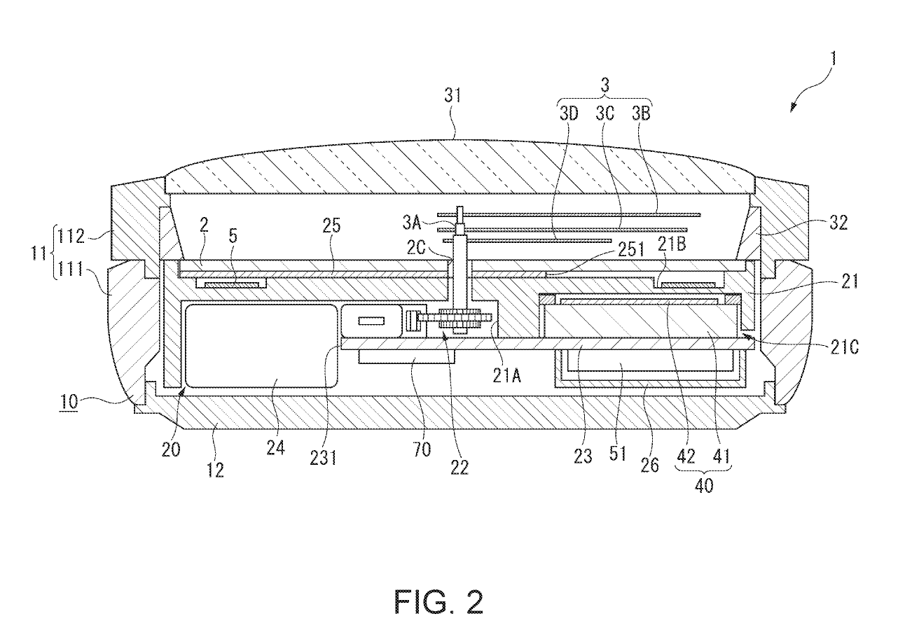

The dial 2 is a disc-shaped member made of polycarbonate or other non-conductive material. The window 2B is located at 3:00 on the dial 2. As shown in FIG. 2, in addition to the window 2B, the dial 2 has a through-hole 2C through which the center pivot 3A of the hands 3 passes. The through-hole 2C is formed in the plane center of the dial 2.

The hands 3 include a second hand 3B, minute hand 3C, and hour hand 3D. The hands 3 and date wheel 5 are driven by stepper motors 221 to 224 through wheel trains as described further below.

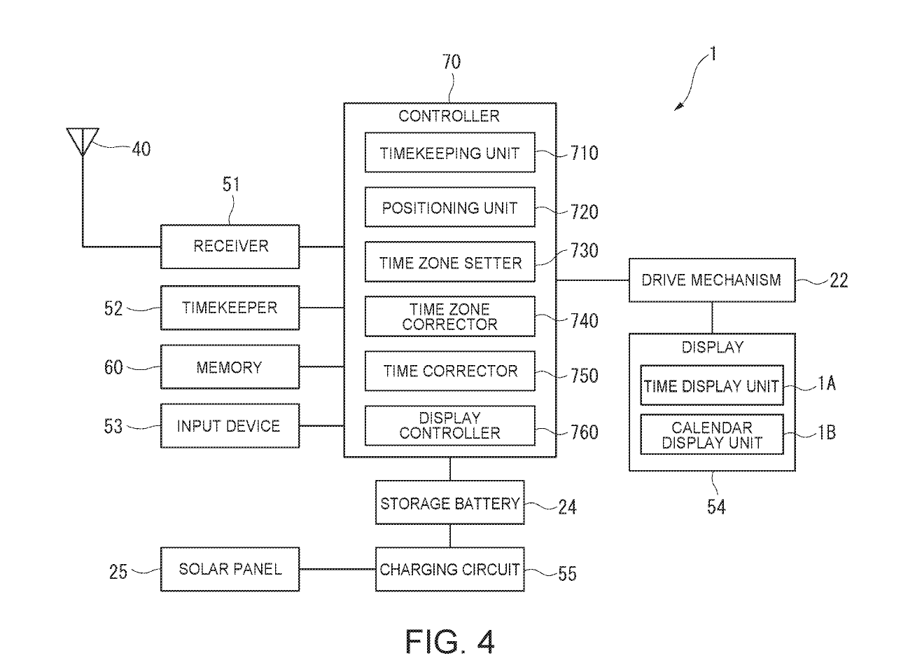

As shown in FIG. 1, the electronic timepiece 1 also has a crown 6 and button 7 as external operating members. The crown 6 and button 7 embody an input device 53 (FIG. 4).

The input device 53 also includes a stem to the distal end of which the crown 6 is attached, a switch wheel attached to the stem, a switch contact spring that is pushed by the switch wheel, and two electrodes disposed to a circuit board 23. The switch wheel causes the switch contact spring to contact one of the two electrodes each time the crown 6 turns right (clockwise) a specific angle. Input is therefore made when right rotation of the crown 6 is detected. Each time the crown 6 turns left (counterclockwise) a specific angle, the switch wheel causes the switch contact spring to contact the other of the two electrodes. As a result, input is also made each time left rotation of the crown 6 is detected.

The electronic timepiece 1 receives satellite signals and acquires satellite time information from multiple GPS satellites orbiting the Earth on known orbits, and can correct internal time information based on the acquired satellite time information.

Note that GPS satellites are just one example of positioning information satellites, and numerous GPS satellites are in orbit. There are presently approximately 30 GPS satellites in service.

External Structure of the Electronic Timepiece

As shown in FIG. 1 and FIG. 2, the electronic timepiece 1 has an external case 10 that houses a movement 20. The case 10 includes the main case 11, and the back cover 12.

The main case 11 includes a cylindrical case member 111, and a bezel 112 disposed on the front side of the case member 111.

The bezel 112 is shaped like a ring. The bezel 112 and case member 111 are connected by an interlocking tongue-and-groove structure formed on their mutual opposing surfaces, or by adhesive or double-sided adhesive tape, for example. The bezel 112 may also be attached so that it can rotate on the case member 111.

The crystal 31 is attached to the inside of the bezel 112 and is held by the bezel 112.

A round back cover 12 is disposed to the back of the main case 11 covering the back cover side opening to the main case 11. The back cover 12 and the outside case member 111 of the main case 11 screw together.

Note that the outside case member 111 and the back cover 12 are discrete members in this embodiment of the invention, but the invention is not so limited and the outside case member 111 and back cover 12 may be formed in unison as a single piece.

The outside case member 111, bezel 112, and back cover 12 are made of brass, stainless steel, titanium alloy, or other conductive metal material.

Internal Configuration of the Electronic Timepiece

The internal structure housed inside the outside case 10 of the electronic timepiece 1 is described next.

As shown in FIG. 1 and FIG. 2, the dial 2, movement 20, planar antenna 40 (patch antenna), date wheel 5, and dial ring 32 are housed inside the case 10.

The movement 20 includes the main plate 21, a drive mechanism 22 supported by the main plate 21, a circuit board 23, a storage battery 24, and a solar panel 25.

The main plate 21 is made from plastic or other non-conductive material. The main plate 21 includes a drive mechanism housing 21A that holds the drive mechanism 22, a date wheel housing 21B where the date wheel 5 is disposed, and an antenna housing 21C that holds the planar antenna 40. The date wheel housing 21B is a ring-shaped recess formed in the surface of the main plate 21. The drive mechanism housing 21A and antenna housing 21C are disposed on the back cover side of the main plate 21.

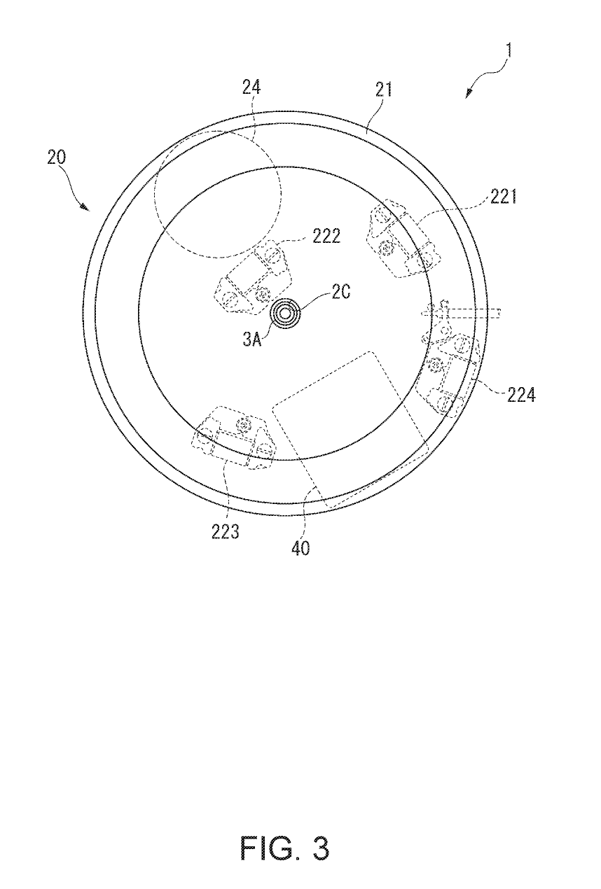

The drive mechanism 22 is held in the drive mechanism housing 21A of the main plate 21, and drives the hands 3 and date wheel 5 of the time display unit 1A, and calendar display unit 1B. More specifically, as shown in FIG. 3, the drive mechanism 22 includes the first stepper motor 221 and first wheel train (not shown in the figure) that drive the hour hand 3D of the hands 3; the second stepper motor 222 and a second wheel train (not shown in the figure) that drive the minute hand 3C of the hands 3; the third stepper motor 223 and third wheel train (not shown in the figure) that drive the second hand 3B of the hands 3; and the fourth stepper motor 224 and fourth wheel train that drive the date wheel 5.

In other words, the first stepper motor 221 embodies an hour hand motor, the second stepper motor 222 embodies a minute hand motor, the third stepper motor 223 embodies a second hand motor, and the fourth stepper motor 224 embodies a date wheel motor.

The circuit board 23 is round and flat, and has a substantially round notch 231 formed where the storage battery 24 is disposed. The dial 2 side surface of the circuit board 23 contacts the back side of the main plate 21, and the circuit board 23 is fastened to the main plate 21 by screw or other fastener. The planar antenna 40 is mounted on the face side of the circuit board 23. A receiver 51, which is a reception unit that processes satellite signals received from the GPS satellites, a controller 70 that controls the stepper motors 221 to 224, and a power supply chip (not shown in the figure), are mounted on the back side of the circuit board 23.

Because the receiver 51, controller 70, and power supply chip are located on the opposite side of the circuit board 23 as the planar antenna 40, digital noise produced by the reception circuit and power supply circuit cannot easily reach the planar antenna 40, and reception performance can be improved.

Furthermore, because the receiver 51 is surrounded by a shield 26, the receiver 51 is also not affected by noise produced by the controller 70.

The storage battery 24 is a flat, round lithium ion coin battery. The storage battery 24 supplies power to the drive mechanism 22, receiver 51, and controller 70. The storage battery 24 is disposed in the notch 231 in the circuit board 23.

The surface electrode of the solar panel 25 is made from indium tin oxide (ITO) or other transparent electrode material to pass light. An amorphous silicon semiconductor thin film is formed as the photovoltaic layer on a plastic film base layer.

Because GPS satellite signals are high frequency signals of approximately 1.5 GHz, GPS signals are attenuated by even thin transparent electrodes, unlike the long wave standard time signals that are received by radio-controlled timepieces, and antenna performance drops. As a result, a notch 251 is formed in the disc-shaped solar panel 25 at the position overlapping the planar antenna 40 in plan view. The solar panel 25 therefore covers the face side of the main plate 21 but does not cover the planar antenna 40. The planar antenna 40 can therefore receive radio waves through the notch 251 in the solar panel 25.

Note that an opening superimposed in plan view with the window 2B in the dial 2, and a hole 253 through which the center pivot 3A of the hands 3 passes, are also formed in the solar panel 25.

The planar antenna 40, which is a patch antenna (microstrip antenna) is disposed in the antenna housing 21C. The planar antenna 40 can receive satellite signals from GPS satellites. The planar antenna 40 is described further below.

The date wheel 5, which is a ring-shaped calendar wheel having date numbers displayed on the surface, is held in the date wheel housing 21B of the main plate 21. The date wheel 5 is made from plastic or other non-conductive material. In plan view, the date wheel 5 overlaps at least part of the planar antenna 40. Note that the calendar wheel is not limited to a date wheel, and may be a day wheel showing the days of the week, or a month wheel showing the months, for example.

The dial 2 is disposed on the face side of the main plate 21 covering the face side of the solar panel 25 and the date wheel 5. The dial 2 is made from a material such as plastic that is non-conductive and transparent to at least some light.

A dial ring 32 that is a ring shaped member made of a plastic non-conductive material (such as ABS plastic) is disposed to the face side of the dial 2. The dial ring 32 is disposed around the circumference of the dial 2. By molding the dial ring 32 from plastic, good reception performance can be assured, complicated shapes can be formed, and design creativity can be improved. The dial ring 32 is held pressed to the dial 2 by the bezel 112.

Planar Antenna

In plan view, the planar antenna 40 is not superimposed with the main case 11 (outside case member 111 and bezel 112) and solar panel 25, and is superimposed with the date wheel 5, dial 2, and crystal 31, which are made from non-conductive materials. More specifically, all parts of the electronic timepiece 1 that are over the planar antenna 40 on the face side of the planar antenna 40 are made from non-conductive materials.

As a result, satellite signals travelling from the face side of the timepiece first pass through the crystal 31, pass through the dial 2, date wheel 5, and main plate 21 without being blocked by the main case 11 or the solar panel 25, and are then incident to the planar antenna 40. Note that because the area of the hands 3 over the planar antenna 40 is small, they do not interfere with receiving satellite signals even if they are made of metal, but are preferably made from a non-conductive material because they will then interfere with satellite signal reception even less.

The GPS satellites transmit satellite signals as right-hand circularly polarized waves. As a result, the planar antenna 40 in this embodiment of the invention is a patch antenna (also called a microstrip antenna) with excellent circular polarization characteristics.

The planar antenna 40 in this embodiment is a patch antenna having a conductive antenna electrode 42 formed on a ceramic dielectric substrate 41.

This planar antenna 40 is manufactured as described below. First, barium titanate with a dielectric constant of 60-100 is formed to the desired shape in a press and sintered to complete the ceramic dielectric substrate 41 of the antenna. A ground electrode (not shown in the figure) forming the ground plane (GND) of the antenna is made by screen printing a primarily silver (Ag) paste, for example, on the back side (the side facing the circuit board 23) of the dielectric substrate 41.

An antenna electrode 42 that determines the antenna frequency and the polarity of the received signals is formed on the face side of the dielectric substrate 41 (the side facing the main plate 21 and dial 2) by the same method as the ground electrode.

The planar antenna 40 is mounted on the face side of the circuit board 23, and is electrically connected to the GPS module, which is the receiver 51, on the back side of the circuit board 23. The circuit board 23 can also function as a ground plane by connecting the ground electrode of the planar antenna 40 through the ground pattern of the circuit board 23 to the ground node of the receiver 51. The case member 111 and back cover 12 can also be used as a ground plane by connecting the ground node of the receiver 51 through the ground pattern of the circuit board 23 to the metal case member 111 or back cover 12.

The planar antenna 40 is disposed in the antenna housing 21C by fastening the circuit board 23 to the main plate 21.

Circuit Configuration of the Electronic Timepiece

FIG. 4 is a block diagram illustrating the circuit configuration of the electronic timepiece 1. The electronic timepiece 1 has a receiver 51, controller 70, timekeeper 52, memory 60, input device 53, and a charging circuit 55 that stores and charges the storage battery 24 with power output by the solar panel 25.

Receiver

The receiver 51 is a load driven by power stored in the storage battery 24, and when driven by the controller 70, receives satellite signals transmitted from GPS satellites through the planar antenna 40. When satellite signal reception is successful, the receiver 51 sends acquired information such as orbit information and GPS time information to the controller 70. When satellite signal reception fails, the receiver 51 sends a failure notice to the controller 70. The configuration of the receiver 51 is the same as the configuration of a GPS receiver known from the literature, and further description thereof is omitted.

Timekeeper

The timekeeper 52 has a crystal oscillator that is driven by power stored in the storage battery 24, and updates the time data using a reference signal based on the oscillation signal from the crystal oscillator.

Input Device

The input device 53 includes the crown 6 and button 7, and sends operating signals to the controller 70 based on the operation of the crown 6 and button 7.

Memory

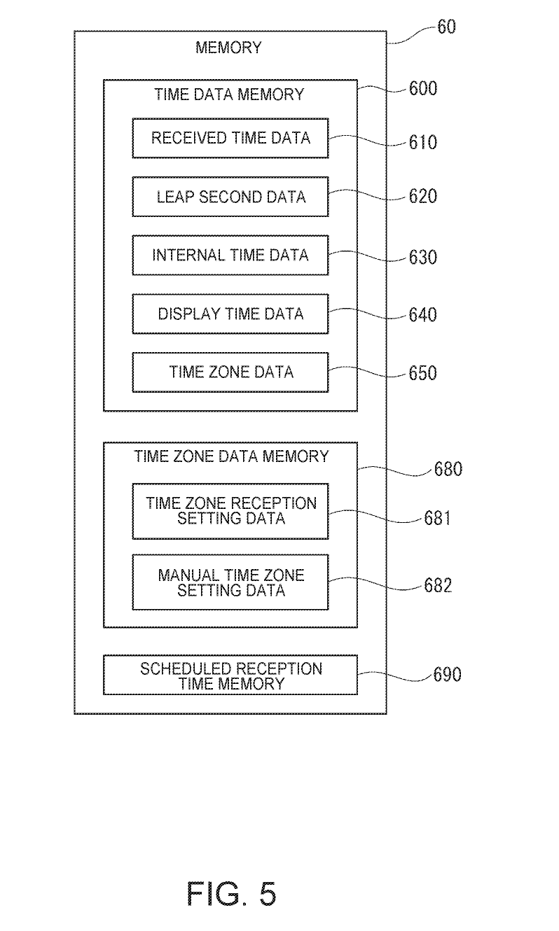

As shown in FIG. 5, the memory 60 includes time data memory 600, time zone data memory 680, and scheduled reception time memory 690.

Received time data 610, leap second data 620, internal time data 630, display time data 640, and time zone data 650 are stored in time data memory 600.

The received time data 610 includes time information (GPS time) acquired from the received satellite signals. The received time data 610 is updated each second by the timekeeper 52, and is corrected based on the acquired time information (GPS time) when satellite signals are received.

The leap second data 620 stores at least the current leap second data. More specifically, the current leap second value, the week number of the leap second event, the day number of the leap second event, and the future leap second value, are stored on page 18 in subframe 4 of the GPS satellite signal as data related to the leap second. Of these values, at least the current leap second value is stored in the leap second data 620.

Internal time information is stored in the internal time data 630. This internal time information is updated based on the GPS time stored in the received time data 610 and the current leap second value stored in the leap second data 620. As a result, UTC is stored in the internal time data 630. When the received time data 610 is updated by the timekeeper 52, the internal time information is also updated.

The sum of the internal time information stored in the internal time data 630 and the time zone data (time zone information, time difference information) stored in the time zone data 650 is stored as the display time data 640. When satellite signals are received in the positioning mode, the time zone data 650 is set based on the location information calculated from the received signals. When time zone information is selected by operating the crown 6 as described below, the time zone data 650 is set based on the selected time zone information.

The time zone data memory 680 stores time zone reception setting data 681 and manual time zone setting data 682. Location information (latitude and longitude), and time zone information (time difference information), are relationally stored in the time zone reception setting data 681. As a result, when location information is acquired in the positioning mode, the controller 70 can acquire the time zone based on the location information (latitude and longitude).

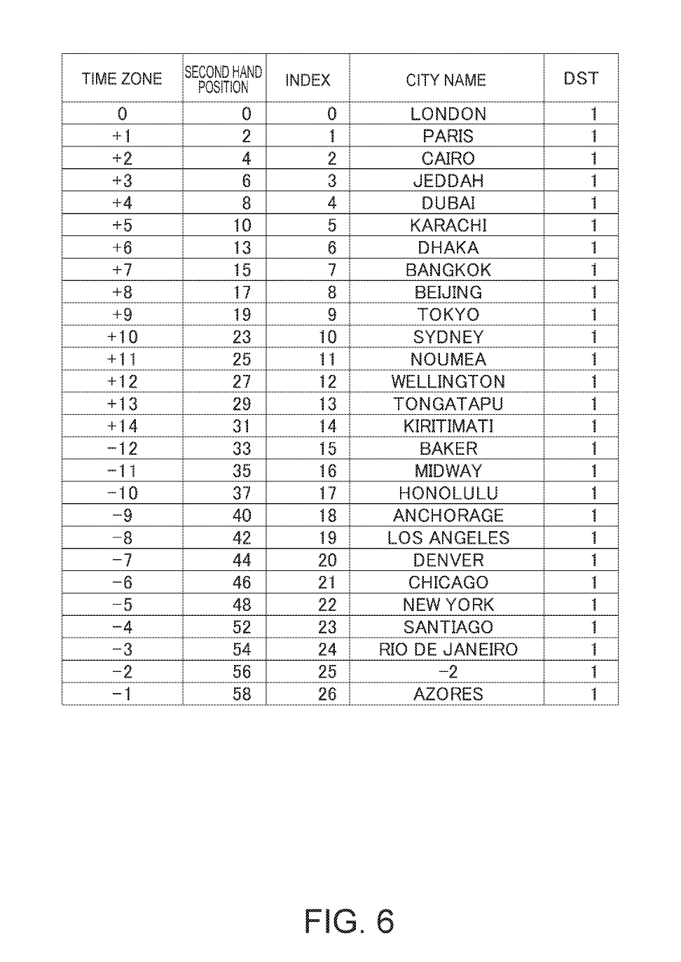

As shown in FIG. 6, time zone information (time difference information), the position indicated by the second hand 3B, an index, the name of a representative city in the region corresponding to the time zone information, and the amount of time added when the DST (daylight saving time) setting is on, are relationally stored in the manual time zone setting data 682. In this embodiment, the manual time zone setting data 682 stores time zone information setting time zones that are ahead of UTC in one-hour increments from +1 to +14 hours from the reference time of UTC (time zone: 0), and setting time zones that are behind UTC in one-hour increments from −1 to −12 hours from the reference time of UTC.

Note that herein the time zone of a maximum +14 hours ahead of UTC is referred to as a first time zone, and the time zone of a maximum −12 hours behind UTC is referred to as a second time zone.

The positions of the second hand 3B in FIG. 6 are the positions pointed to by the second hand 3B when city names representative of the time zone are displayed on the case 10, for example. However, because this embodiment of the invention does not show city names or time difference information on the case 10, the ability to indicate with the second hand 3B what time zone is set is also omitted.

While described in detail below, the controller 70 can select time zone information stored in the manual time zone setting data 682 in response to operation of the crown 6, and can set the selected time zone information in the time zone data 650.

The scheduled reception time memory 690 stores the scheduled reception time when the timekeeping unit 710 executes the scheduled reception process. The scheduled reception time stores the time that the manual reception process was executed and successful in response to operation of the button 7.

Controller

The controller 70 is a CPU that controls the electronic timepiece 1. The controller 70 includes a timekeeping unit 710, positioning unit 720, time zone setter 730, time zone corrector 740, time corrector 750, and display controller 760.

Timekeeping Unit

The timekeeping unit 710 drives the receiver 51 to execute the reception process in the timekeeping mode. The timekeeping mode reception process in this embodiment includes an automatic reception process and a manual reception process.

The automatic reception process includes a scheduled automatic reception process and a light-based automatic reception process.

More specifically, the timekeeping unit 710 operates the receiver 51 to execute the scheduled automatic reception process in the timekeeping mode when the internally-kept display time data 640 reaches the scheduled reception time stored in the scheduled reception time memory 690.

When the voltage or current output of the solar panel 25 reaches a specific threshold and the solar panel 25 can be determined to be exposed to sunlight outdoors, the timekeeping unit 710 drives the receiver 51 to execute the light-based automatic reception process in the timekeeping mode. Note that the number of times the process driving the receiver 51 based on the output of the solar panel 25 executes may be limited to once a day, for example.

When the user pushes the button 7 to manually start reception, the timekeeping unit 710 operates the receiver 51 to execute the manual reception process in the timekeeping mode.

The timekeeping unit 710 acquires time information by the receiver 51 locking onto at least one GPS satellite and receiving satellite signals transmitted from that GPS satellite.

Positioning Unit

The positioning unit 720 drives the receiver 51 to execute the reception process in the positioning mode when the user pushes the button 7 to start the manual reception process.

The controller 70 sets the reception process to the timekeeping mode reception process of the timekeeping unit 710, or the positioning mode reception process of the positioning unit 720, according to how long the button 7 is pushed. For example, the controller 70 sets the reception process to the timekeeping mode when the button 7 is pushed for a first set time (greater than or equal to 3 seconds and less than 6 seconds), and sets the reception process to the positioning mode when the button 7 is pushed for a second set time (greater than or equal to 6 seconds).

When the positioning unit 720 starts the reception process in the positioning mode, the receiver 51 locks onto at least 3 and preferably 4 GPS satellites, receives satellite signals from each of the GPS satellites, and calculates and acquires positioning information. The positioning unit 720 can also acquire time information from the received satellite signals.

Time Zone Setter

The time zone setter 730 sets the time zone data 650 based on the acquired positioning information (latitude and longitude) when positioning information acquisition by the positioning unit 720 is successful. More specifically, the time zone setter 730 selects, acquires, and stores in the time zone data 650 the time zone data (time zone information; time difference information) corresponding to the positioning information from the time zone reception setting data 681 stored in time zone data memory 680.

For example, because Japan Standard Time (JST) is 9 hours ahead of UTC (UTC+9), when the positioning information the positioning unit 720 indicates a location in Japan, the time zone setter 730 reads from time zone data memory 680 and stores to the time zone data 650 the time difference of Japan Standard Time (+9 hours).

The time zone setter 730 also selects and acquires time zone information from the manual time zone setting data 682 in response to rotation of the crown 6, and stores the time zone information in the time zone data 650. Note that the method of setting the time zone data 650 according to rotation of the crown 6 is described in detail below.

Time Zone Corrector

When the time zone setter 730 sets the time zone information, the time zone corrector 740 corrects the display time data 640 based on the time zone data 650. As a result, the display time data 640 is set to the internal time data 630 (UTC) plus the time zone data 650.

Time Corrector

When acquisition of time information is successful in the reception process of the timekeeping unit 710 or positioning unit 720, the time corrector 750 corrects the received time data 610 based on the acquired time information. As a result, the internal time data 630 and display time data 640 are also corrected. When the display time data 640 is corrected, the time indicated by the hands 3 synchronized to the display time data 640 is also corrected. Note that the hands 3 are synchronized to the display time data 640 using a hand position detection means known from the literature.

Display Controller

The display controller 760 controls the drive mechanism. 22 to control display by the 54, which comprises the time display unit 1A and calendar display unit 1B. More specifically, the display controller 760 controls the drive mechanism 22 to control movement of the hands 3 and date wheel 5.

Time Zone Setting Process

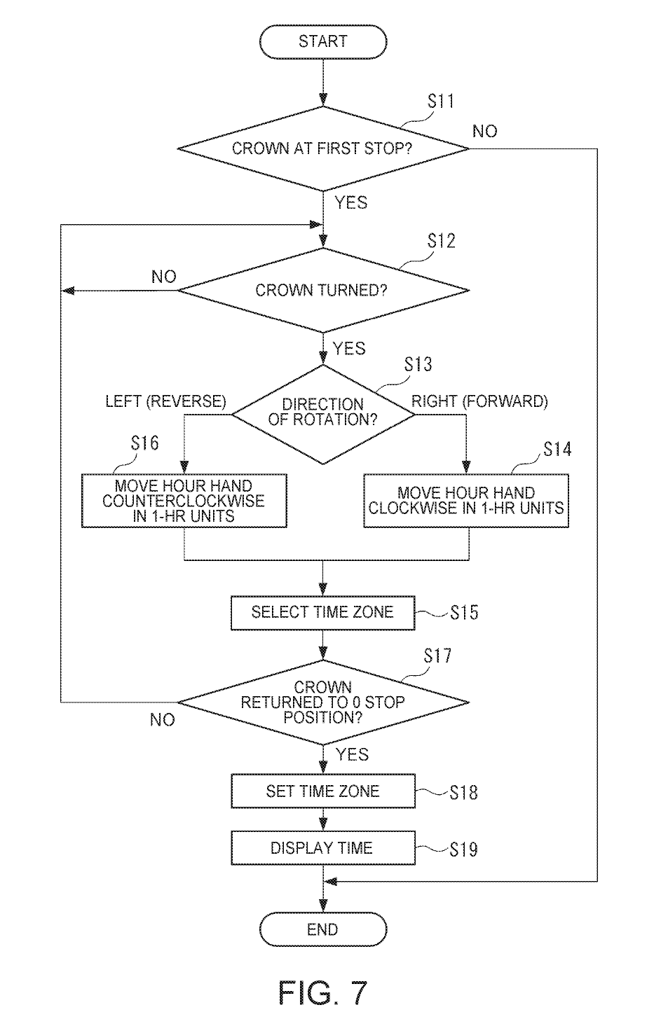

FIG. 7 is a flowchart of the time zone setting process the electronic timepiece 1 executes. The time zone correction mode is selected when the crown 6 is pulled out to the first stop in this embodiment of the invention.

The controller 70 determines if the crown 6 was pulled out to the first stop (S11). The controller 70, if S11 returns NO, ends the process in FIG. 7. Because the process in FIG. 7 executes at a regular time interval, the controller 70 repeats step S11 at the regular time interval while S11 returns NO.

If S11 returns YES, the controller 70 starts the time zone setting process, and based on the operating signal output from the input device 53, determines if there was input from rotation of the crown 6 (S12). If S2 returns NO, the controller 70 repeats S12.

If S12 returns YES, the controller 70 determines whether the crown 6 was turned right (forward; counterclockwise rotation) or left (reverse; counterclockwise rotation) (S13). Note that the direction of crown 6 rotation as used herein is the direction of rotation when looking at the crown 6 from the outside of the electronic timepiece 1.

If the crown 6 turned right, the display controller 760 moves the hour hand 3D clockwise so that the hour hand 3D points to the time (hour) one hour ahead of (after) the time (hour) currently indicated by the hour hand 3D (S14).

Next, in S15, the time zone setter 730 references the manual time zone setting data 682, and selects the time zone information corresponding to the time indicated by the hour hand 3D after moving in S14. In other words, the time zone setter 730 selects the time zone information for the time zone information one hour later than the currently set time zone.

Steps S12 to S17 repeat as described below while S17 returns NO. Therefore, if input of right rotation of the crown 6 continues, and the process of S15 executes two or more times, the time zone setter 730 continues to select the time zone information corresponding to the time indicated by the hour hand 3D after moving in S14, that is, the time zone one hour later than the previously selected time zone.

For example, if the currently set time zone information is +9 hours, and right rotation is input once, the time zone setter 730 selects time zone information for +10 hours, and if right rotation is input three times, selects time zone information for +12 hours.

If the currently set or selected time zone is the maximum +14 hours (is the first time zone), the display controller 760 does not advance the hour hand 3D in S14 even if right rotation for advancing the time is input. As a result, the time zone information the time zone setter 730 selects in S15 remains +14 hours.

If rotation of the crown 6 is left, the display controller 760 moves the hour hand 3D counterclockwise, and sets the hour hand 3D to indicate the time of the time currently indicated by the hour hand 3D minus one hour (delays the time) (S16).

Next, in S15, the time zone setter 730 references the manual time zone setting data 682, and selects the time zone information corresponding to the time indicated by the hour hand 3D in S16. In other words, the time zone setter 730 selects the time zone information for the time zone information one hour earlier than (before) the currently set time zone.

If input of left rotation of the crown 6 continues, and the process of S15 executes two or more times, the time zone setter 730 continues to select the time zone information corresponding to the time indicated by the hour hand 3D after moving in S16, that is, the time zone one hour earlier than the previously selected time zone.

For example, if the currently set time zone information is +9 hours, and left rotation is input once, the time zone setter 730 selects time zone information for +8 hours, and if left rotation is input three times, selects time zone information for +6 hours.

If the currently set or selected time zone is the maximum −12 hours (is the second time zone), the display controller 760 does not advance the hour hand 3D in S16 even if left rotation for reversing the time is input. As a result, the time zone information the time zone setter 730 selects in S15 remains −12 hours.

After S15, the time zone setter 730 determines if the crown 6 returned to the 0 stop position (S17). The time zone setter 730 returns to S12 if S17 returns NO. As a result, if there is further input of crown 6 rotation, steps S13-S17 repeat.

If S17 returns YES, the time zone setter 730 updates the time zone data 650 to the selected time zone information, and sets the time zone data (S18). As a result, the display time data 640 is corrected by the time zone corrector 740, and is set to the internal time data 630 (UTC) plus the set time zone data 650. The display controller 760 then controls the hour hand 3D, minute hand 3C, second hand 3B, and date wheel 5 to display the time expressed by the display time data 640 (S19).

The controller 70 then ends the time zone setting process. Whether or not the crown 6 was pulled out to the first stop is then determined at a regular interval in S11, and if pulled out to the first stop, the time zone setting process repeats.

Correcting the Time Zone

An example of correcting the time zone is described next.

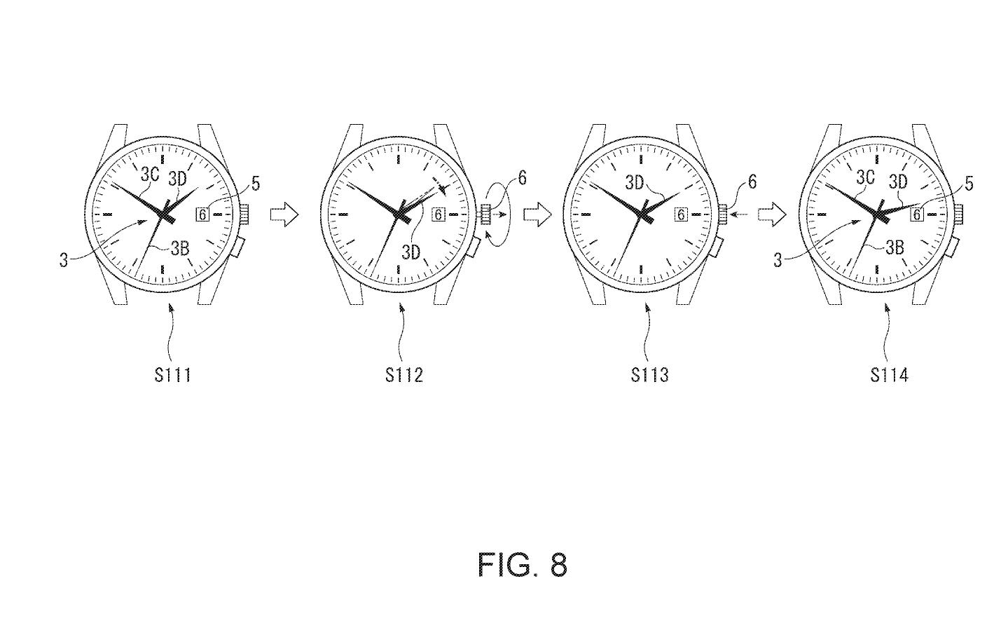

FIG. 8 shows an example in which the time zone data 650 that is currently set is +5 hours (Karachi), the displayed time is changed from 13:50 on the 6^{th} to 14:50 on the 6^{th}, and the time zone data is set to +6 hours (Dhaka).

In this example, as shown in S112, the crown 6 is pulled out to the first stop to select the time zone correction mode. This stops movement of the second hand 3B, minute hand 3C, and hour hand 3D. When the crown 6 is then turned right once, the hour hand 3D turns clockwise, and points to the 14:00 (13:00+1) (10 second) position. As a result, time zone information for +6 hours (=+5 hours+1 hour).

Next, as shown in S113, pushing the 6 back to the 0 stop position sets the time zone data 650 to +6 hours, and the time at the internal time information (UTC) plus 6 hours (6^{th}, 14:50) is displayed by the hands 3 and date wheel 5. More specifically, the hour hand 3D, which was pointing to the 14:00 position, is advanced to the position between 14:00 and 15:00 corresponding to the time 14:50. Because the internal time information is still updated during the time zone setting operation, if the time when the crown 6 is returned to the 0 stop position is 14:50:20, the minute hand 3C and second hand 3B are also advanced to the positions corresponding to the internal time information.

Note that this embodiment of the invention cannot set time zones that are not a multiple of one different from UTC, such as a time zone that is 5.5 hours offset from UTC. In this event, when time zone data corresponding to the time difference to the location for GPS positioning is set in 1-hour increments, the time zone data will be set to +5 or +6 hours in a time zone with a time difference of +5.5 hours. As a result, to set the displayed time to the current time (the time in a time zone of +5.5 hours), the display time data 640 can be set using the normal time setting function. For example, the crown 6 is pulled out to the second stop and the button 7 is pushed to enter the normal time setting mode. In this time setting mode, when the user turns the crown 6, the controller 70 changes the display time data 640 according to the rotation of the crown 6, and the display controller 760 moves the hour and minute hands. The controller 70 also corrects the internal time data 630 and received time data 610 according to the display time data 640. The controller 70 does not change the time zone data 650.

However, if location information is acquired by the positioning mode reception process, the display time data 640 is corrected to the time of UTC plus the time of the currently set time zone data, and is thus reset to the time of the set time zone (for example, the time at +5 or +6 hours). In this event, the user can simply correct the time using the normal time setting function.

Effect of Embodiment 1

In the time zone correction mode, this embodiment of the invention can move the hour hand 3D directly by turning the crown 6 at the first stop, and the time zone data that is set can be corrected based on the time zone data corresponding to the displayed time selected from the manual time zone setting data 682 after the hour hand 3D moved. As a result, if the user knows the local time or the time difference in the current location, the user can easily change the time zone data 650 by directly moving the hour hand 3D even without knowing the time zone of the current location.

Furthermore, because the hour hand 3D only needs to be directly moved commensurately to the time difference, the user can intuitively and quickly correct the time difference.

In addition, because city names and time difference markers indicating the time zone are not displayed on the case 10 of the electronic timepiece 1, the invention can also be used in small timepieces, such as a ladies' wristwatch, and timepiece design can be improved.

The hour hand 3D and minute hand 3C can also be moved independently because there is a first stepper motor 221 for moving the hour hand, and a separate second stepper motor 222 for moving the minute hand. Movement of the hour hand 3D and minute hand 3C can therefore be minimized, and the time zone data 650 can be corrected more quickly than a configuration driving both the hour hand 3D and minute hand 3C with a single motor.

The electronic timepiece 1 also has a receiver 51, and can set the time zone data 650 based on time zone reception setting data 681 acquired by receiving satellite signals and calculating the current location. Correction based on received signals is therefore possible wherever the signals can be received, manual correction is also possible where the signals cannot be received, such as in an airplane, and user convenience can be improved.

If the crown 6 is turned to advance the time, and a time corresponding to +14 hours is displayed, the time is not updated further by turning the crown 6, and if the crown 6 is turned to reverse the time and a time corresponding to −12 hours is displayed, the time is not updated further. As a result, the user can easily know the selected time zone data 650, and confusion can be prevented.

### Embodiment 2

The electronic timepiece 1 in the first embodiment described above sets the time zone data 650 in one hour increments. The second embodiment described below enables setting the time zone data 650 in minimum increments of 0.25 hour. The time zone correction mode is therefore configured to switch between an hour hand setting mode and a minute hand setting mode.

The construction and circuit configuration of the electronic timepiece 1 according to the second embodiment of the invention are the same as the electronic timepiece 1 of the first embodiment, and further description thereof is omitted.

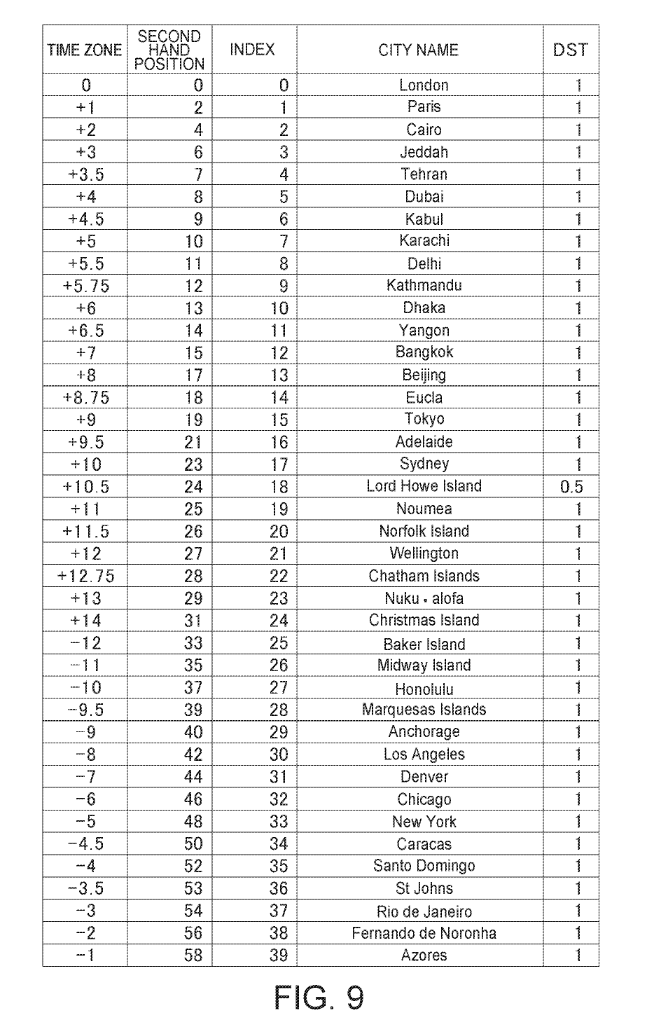

The manual time zone setting data 682 of a electronic timepiece 1 according to the second embodiment of the invention stores the most recent time zone information, enabling setting time zones in increments of a minimum 0.25 hour as shown in FIG. 9.

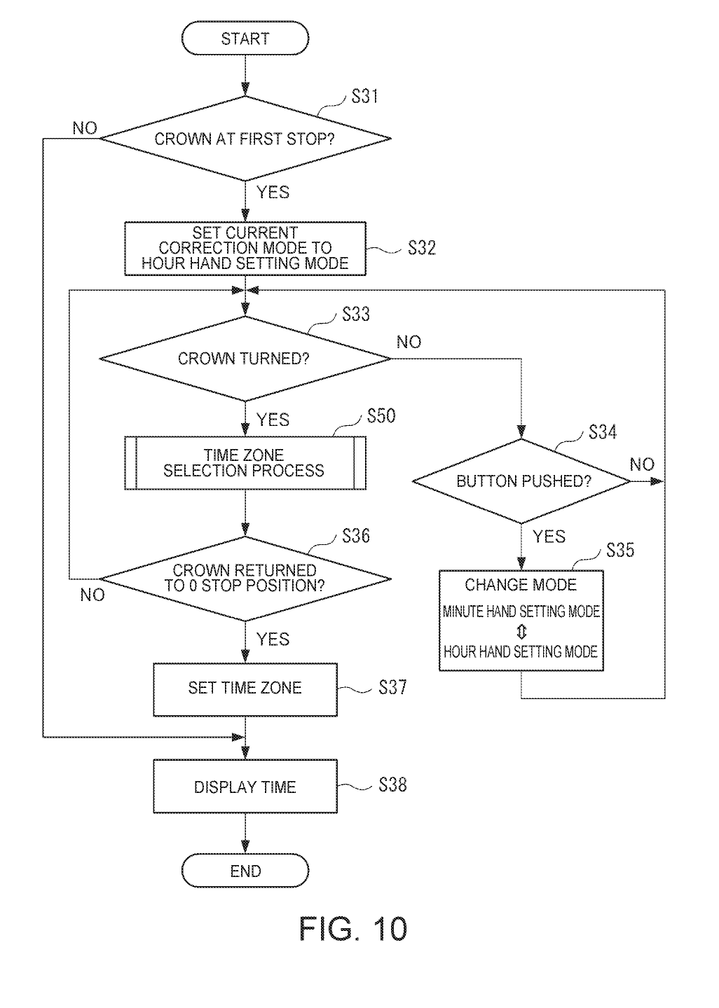

FIG. 10 is a flow chart of the time zone setting process executed in the second embodiment.

The controller 70 determines if the crown 6 was pulled out to the first stop (S31). The controller 70 executes the process shown in FIG. 10 at a regular time interval, and repeats step S31 at the regular time interval if S31 returns NO.

If S31 returns YES, the controller 70 starts the time zone setting process, and sets the initial correction mode to the hour hand setting mode for setting the time zone in 1-hour increments in conjunction with movement of the hour hand 3D (S32). Note that if the button 7 is not pushed to go to the minute hand setting mode within a specific time after the hour hand setting mode is set, the hour hand 3D jumps to the 00:00 position to show that the hour hand setting mode is set.

Based on the operating signal output from the input device 53, the controller 70 then determines if the crown 6 was turned (S33).

If S33 returns NO, the controller 70 determines if the button 7 was pushed (S34). If S34 returns NO, the controller 70 returns to S33.

However, if S34 returns YES, the controller 70 changes the correction mode to whichever of the hour hand setting mode and minute hand setting mode is not currently set (S35), and then returns to S33. Note that the minute hand setting mode is a correction mode for changing the time zone in 0.25-hour increments or 0.5-hour increments in conjunction with movement of the minute hand 3C.

The controller 70 thus switches between the hour hand setting mode and minute hand setting mode each time the button 7 is pushed.

When rotation of the crown 6 is detected and input, and S33 returns YES, the controller 70 executes the time zone selection process S50.

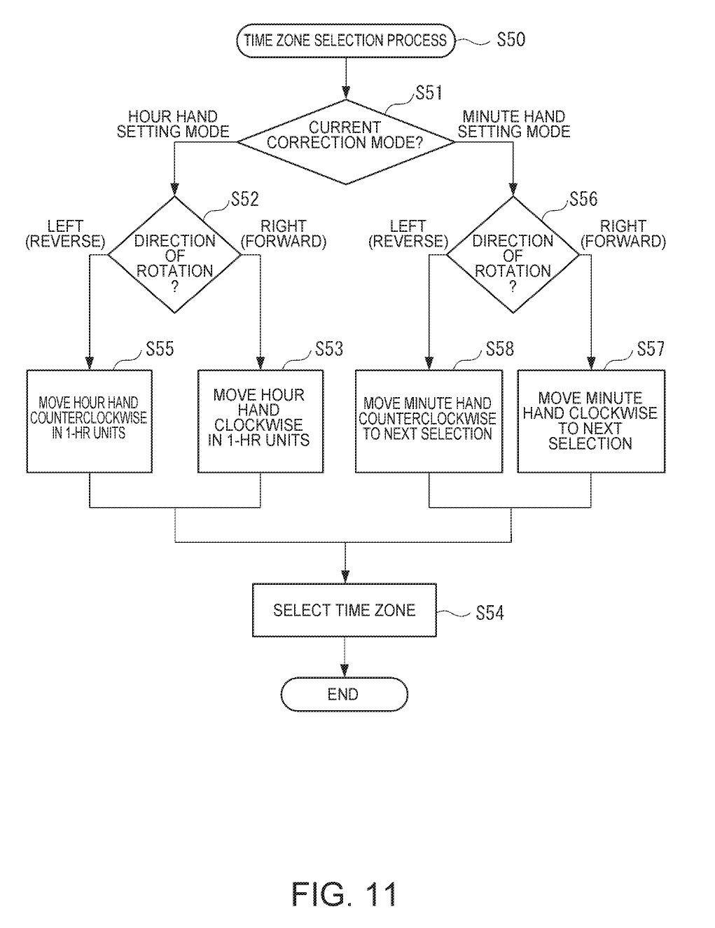

FIG. 11 is a flow chart of the time zone selection process S50.

When the time zone selection process S50 executes, the controller 70 determines if the currently set correction mode is the hour hand setting mode or minute hand setting mode (S51).

If the currently set correction mode is the hour hand setting mode, the controller 70 determines whether the crown 6 was turned right (forward; counterclockwise rotation) or left (reverse; counterclockwise rotation) (S52).

If the crown 6 turned right, the display controller 760 moves the hour hand 3D clockwise so that the hour hand 3D points to the time (hour) one hour ahead of (after) the time (hour) currently indicated by the hour hand 3D (S53).

Next, in S54, the time zone setter 730 references the manual time zone setting data 682, and selects the time zone information corresponding to the time indicated by the hour hand 3D after moving in S53. In other words, the time zone setter 730 selects the time zone information for the time zone information one hour later than the currently set time zone. For example, if the currently set time zone information is +5.5 hours and the displayed time is 5:20, when the crown 6 is at the first stop, the hour hand 3D moves to the 5:00 (25-second) position, the hour hand 3D moves to the 6:00 position when the crown 6 is turned right once. Because the minute hand 3C does not move in this event, the hour hand 3D and minute hand 3C indicate the time zone information is a time of +6.5 hours, and the time zone setter 730 selects time zone information of +6.5 hours.

If input indicating right rotation of the crown 6 is detected twice, the hour hand 3D moves to the 7:00 position, the minute hand 3C does not move, and the hour hand 3D and minute hand 3C indicate the time zone information is a time that should be +7.5 hours. However, as shown in FIG. 9, there is not a time zone of +7.5 hours. As a result, the time zone setter 730 selects time zone information for a location where the hour hand 3D could be at 7:00 based on the position of the minute hand 3C.

For example, if the currently set time zone information is +5.5 hours and the displayed time is 5:20, the time will be 6:50 if the time zone is corrected to +7 hours, and the time will be 7:50 if the time zone is corrected to +8 hours. The time zone setter 730 therefore selects time zone information of +8 hours where the hour hand 3D would be at the 7:00 position.

Likewise, if the currently set time zone information is +5.5 hours and the displayed time is 5:40, the time will be 7:10 if the time zone is corrected to +7 hours, and the time will be 8:10 if the time zone is corrected to +8 hours. The time zone setter 730 therefore selects time zone information of +7 hours where the hour hand 3D would be at the 7:00 position.

If there are multiple candidates from which the time zone information could be selected, the time zone setter 730 selects the time zone information with the time closest to the current minute hand 3C position.

Furthermore, if multiple time zones could be selected based on the position of the hour hand 3D after being moved, the time zone information selection can be changed in the minute hand setting mode described below.

If the crown 6 is turned left, the display controller 760 moves the hour hand 3D counterclockwise, and sets the hour hand 3D to the time one hour before the time indicated by the hour hand 3D (S55).

Next, in S54, the time zone setter 730 references the manual time zone setting data 682, and selects time zone information corresponding to the time indicated by the hour hand 3D after moving in S55. In other words, as when the crown 6 turns right, the time zone setter 730 selects the appropriate time zone information based on the position of the hour hand 3D after moving.

If in S51 the currently set correction mode is the minute hand setting mode, the time zone setter 730 references the manual time zone setting data 682, and extracts time zone information that could be set without advancing or reversing the time (hour) indicated by the hour hand 3D.

For example, suppose the currently set time zone information is +5 hours and the hour hand 3D and minute hand 3C indicate a time of 14:20. If +5.5 hours is set as the time zone, the time will be set to 14:50, which is in the 14:00 hour, but if a time of +5.75 hours is set, the time will go to 15:05, and the hour value will increase. If +4.5 hours is set as the time zone, the time will be set to 13:50, and the hour value will decrease. As a result, the time zone setter 730 extracts +5.5 hours as the time zone information adding +5 hours to the currently set or selected time.

The controller 70 then determines whether the crown 6 was turned right (forward; counterclockwise rotation) or left (reverse; counterclockwise rotation) (S56).

If the crown 6 turned right, the display controller 760 moves the minute hand 3C clockwise to the time of the next selection based on the extracted time zone information (S57). In the above example, if the crown 6 turns right from the position indicating 14:20, the display controller 760 moves the minute hand 3C to the 50-minute position. If the crown 6 turns right with the minute hand 3C at the 50-minute position, the display controller 760 moves the minute hand 3C to the 20-minute position.

If the crown 6 is turned left in S56, the display controller 760 likewise moves the minute hand 3C counterclockwise to the next selection based on the extracted time zone information (S58).

Next, in S54, the time zone setter 730 references the manual time zone setting data 682, and selects the time zone information corresponding to the time indicated by the minute hand 3C after moving in S57, S58 and the hour hand 3D.

In this example, if 14:50 is indicated, +5.5 hours is selected as the time zone information, and if 14:20 is indicated, +5 hours is selected as the time zone information.

The controller 70 then ends the time zone selection process S50.

Returning to FIG. 10, after executing the time zone selection process S50, the time zone setter 730 determines if the crown 6 was returned to the 0 stop position (S36). The time zone setter 730 returns to S33 if S36 returns NO. As a result, if there is further input of crown 6 rotation, the time zone selection process S50 repeats.

However, if S36 returns YES, the time zone setter 730 updates the time zone data 650 based on the selected time zone information and sets the time zone data (S37). As a result, the display time data 640 is corrected by the time zone corrector 740, and is set to the time of the internal time data 630 plus the set time zone data 650. The display controller 760 then controls the hour hand 3D, minute hand 3C, second hand 3B, and date wheel 5 to display the time expressed by the display time data 640 (S38).

The controller 70 then ends the time zone setting process.

Correcting the Time Zone

An example of correcting the time zone is described next.

Changing the time zone by changing only the minute and not the hour is described first.

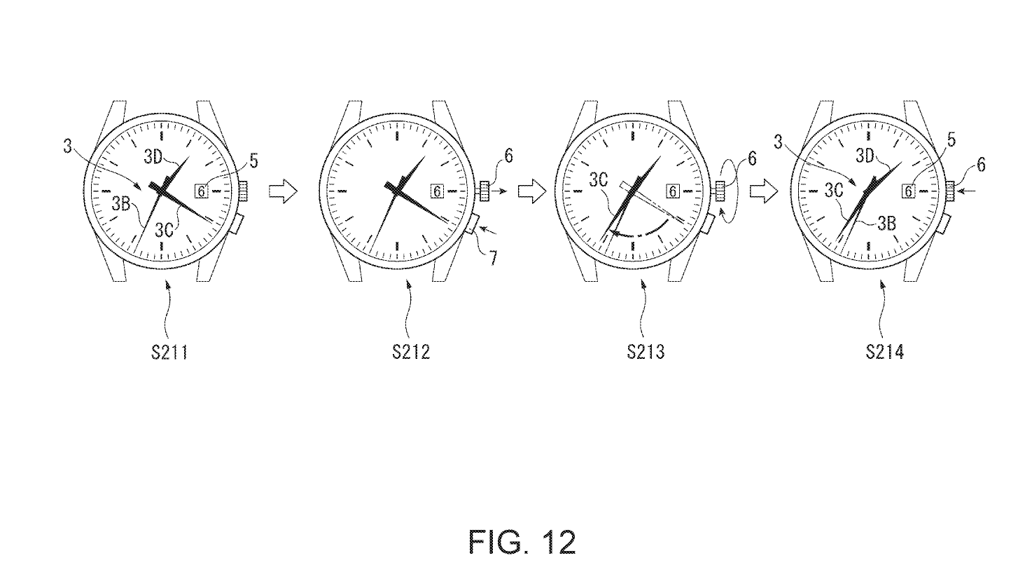

FIG. 12 shows an example in which the time zone data 650 that is currently set is +5.75 hours (Katmandu), the displayed time is changed from 13:20 on the 6^{th} to 13:35 on the 6^{th}, and the time zone data is set to +6 hours (Dhaka).

In this example, as shown in S212, the crown 6 is pulled out to the first stop, and button 7 is pushed once, to select the minute hand setting mode. As a result, +5.5 hours (15 minutes before at 13:05), +5.75 hours (the currently set time zone information), and +6 hours (30 minutes after at 13:35) are extracted as the selectable time zone information.

Next, right rotation of the crown 6 is input once. As a result, as shown in S213, the minute hand 3C turns 15 minutes clockwise to the 35 minute position, and time zone information of +6 hours is selected.

As shown in S214, when the crown 6 returns to the 0 stop position, +6 hours is set as the time zone data 650, and the internal time information plus 6 hours (the 6th at 13:35) is indicated by the hands 3 and date wheel 5.

If right rotation of the crown 6 is input twice, the minute hand 3C turns clockwise from the 20 minute position past the 35 minute position to the 05 minute position. If right rotation of the crown 6 is input three times, the minute hand 3C moves clockwise from the 20 minute position past the 35 minute position and 05 minute position to the 20 minute position.

If left rotation of the crown 6 is input once, the minute hand 3C turns counterclockwise from the 20 minute position to the 05 minute position. If left rotation of the crown 6 is input twice, the minute hand 3C moves counterclockwise from the 20 minute position past the 05 minute position to the 35 minute position.

The time zone correction mode changing the hour and the minute is described next.

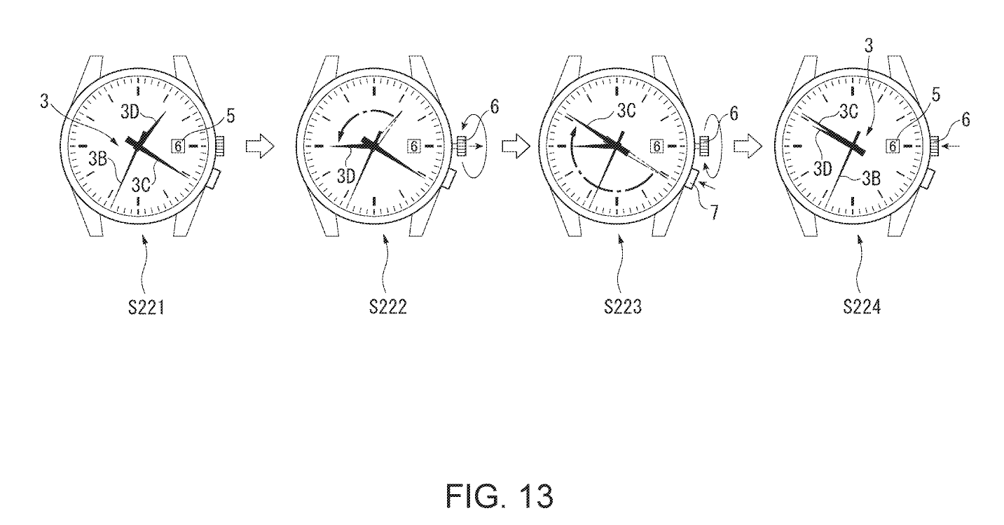

In the example in FIG. 13, the currently set time zone data 650 is +9 hours (Tokyo), and as shown in S221 in FIG. 13, the displayed time changes from the 6th at 13:20 to the 6th at 9:50, and the time zone data is set to +5.5 hours (Delhi).

In this case, as shown in S222, the crown 6 is pulled out to the first stop to set the hour hand setting mode. The crown 6 is then turned left four times, moving the hour hand 3D counterclockwise to the 9:00 position. While not shown in the figure, when the hour hand setting mode is set, the hour hand 3D first indicates 1:00, and then moves sequentially counterclockwise to 12:00, 11:00, 10:00, and 9:00 by turning the crown 6 left four times. After the hour hand 3D moves, the hour hand 3D and minute hand 3C point to 9:20. As a result, time zone information of +5 hours (=+9 hours-4 hours) is selected.

Next, as shown in S223, the button 7 is pushed once to select the minute hand setting mode. As a result, +5 hours (the currently set time zone), and +5.5 hours (30 minutes after at 9:50) are extracted as the selectable time zone information.

Next, the crown 6 is turned right once. As a result, as shown in S223, the minute hand 3C moves clockwise to the next selection candidate, 50 minutes, and +5.5 hours is selected as the time zone information.

Then as shown in S224, by pushing the crown 6 in to the 0 stop position, the time zone data 650 is set to +5.5 hours, and the hands 3 and date wheel 5 display the internal time information plus 5.5 hours (the 6th at 9:50).

Another example of the time zone correction mode changing the hour and the minute is described next.

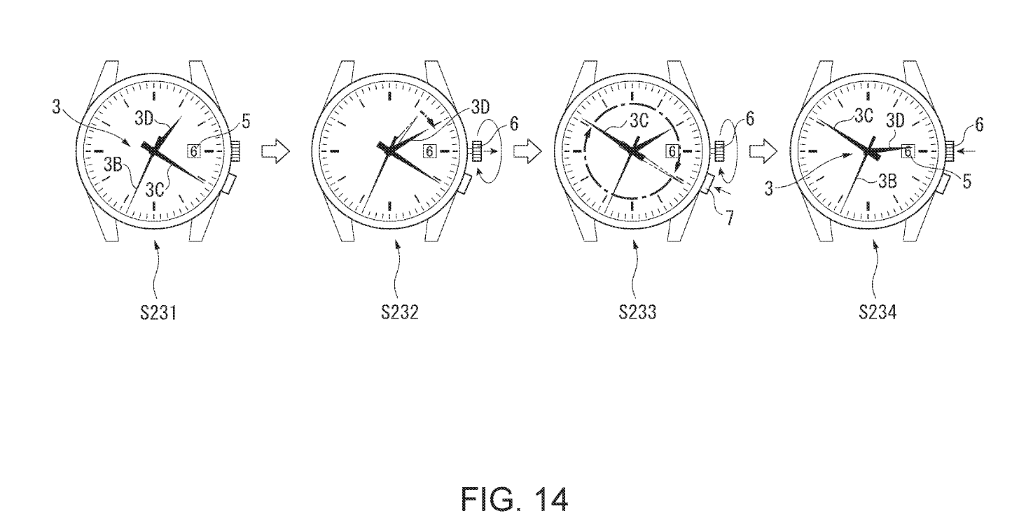

In the example in FIG. 14, the currently set time zone data 650 is +4 hours (Dubai), and as shown in S224 in FIG. 14, the displayed time changes from the 6th at 13:20 to the 6th at 14:50, and the time zone data is set to +5.5 hours (Delhi).

In this case, as shown in S232, the crown 6 is pulled out to the first stop to set the hour hand setting mode. While not shown in the figure, the hour hand 3D jumps to 13:00. The crown 6 is then turned right once, moving the hour hand 3D counterclockwise to the 14:00 position. More specifically, the hour hand 3D and minute hand 3C indicate 14:20. As a result, time zone information of +5 hours (=+4 hours+1 hour) is selected.

Next, as shown in S233, the button 7 is pushed once to select the minute hand setting mode. As a result, +5 hours (the currently set time zone), and +5.5 hours (30 minutes after at 14:50) are extracted as the selectable time zone information.

Next, the crown 6 is turned right once. As a result, as shown in S233, the minute hand 3C moves clockwise to the next selection candidate, 50 minutes, and +5.5 hours is selected as the time zone information. If the crown 6 is turned right once again, the minute hand 3C turns clockwise to the original position, and +5 hours is selected as the time zone information. As a result, each time the crown 6 turns right once, +5.5 hours and +5 hours are alternately selected as the time zone information. The same applies if the crown 6 is turned left.

Then as shown in S234, by pushing the crown 6 in to the 0 stop position, the time zone data 650 is set to +5.5 hours, and the hands 3 and date wheel 5 display the internal time information plus 5.5 hours (the 6th at 14:50).

Effect of Embodiment 2

This embodiment has the same effect as the first embodiment described above.

This embodiment also has an hour hand setting mode in which the crown 6 directly moves the hour hand 3D, and a minute hand setting mode in which the crown 6 directly moves the minute hand 3C, and can change the currently set time zone data 650 based on time zone data corresponding to the displayed time after the hour hand 3D and minute hand 3C are moved. As a result, if the user knows the local time or the time difference in the current location, the user can easily change the time zone data 650 by directly moving the hour hand 3D and minute hand 3C even without knowing the time zone of the current location.

Furthermore, because the hour hand 3D and minute hand 3C only need to be directly moved commensurately to the time difference, the user can intuitively and quickly correct the time difference. Furthermore, because the hour hand 3D can be moved alone in the hour hand setting mode, the time zone data 650 can be quickly corrected when there is no need to move the minute hand 3C.

In addition, because the minute hand 3C can be moved alone in the minute hand setting mode, time zones that also require correcting the minute can be set, and the time can be displayed more accurately.

This embodiment of the invention can appropriately set the position to which the minute hand 3C moves according to the position of the hour hand 3D, can minimize the number of times the crown 6 is operated in the minute hand setting mode, and can quickly adjust the time zone data 650.

### Embodiment 3

The electronic timepiece 1 according to the third embodiment of the invention is configured to enable moving the hour hand 3D and minute hand 3C based on time zone information stored in the manual time zone setting data 682 by turning the crown 6 when setting the time zone data 650.

The construction and circuit configuration of the electronic timepiece 1 according to the third embodiment of the invention are the same as the electronic timepiece 1 of the first embodiment, and further description thereof is omitted.

The manual time zone setting data 682 of a electronic timepiece 1 according to the third embodiment of the invention stores time zone information enabling setting time zones in increments of a minimum 0.25 hour as shown in FIG. 9.

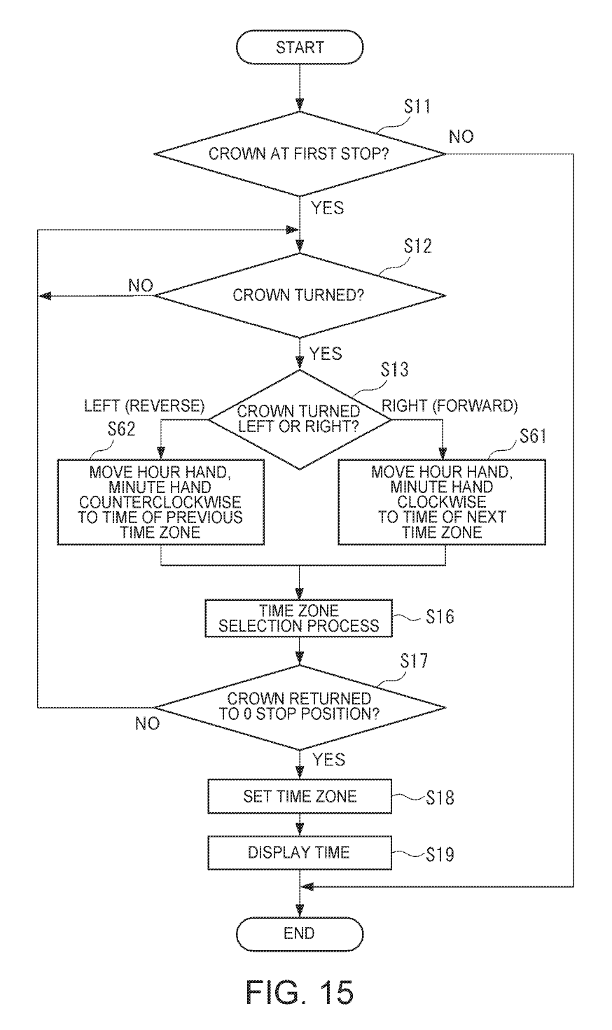

As shown in FIG. 15, the time zone setting process of the third embodiment executes steps S11-S13, S17-S19, S61-S62. Steps S11-S13, S17-S19 are the same as S11-S13, S17-S19 in the first embodiment, and further description thereof is omitted.

In the time zone setting process of this embodiment, when S13 determines the crown 6 turned right, the display controller 760 moves the hour hand 3D and minute hand 3C to the positions corresponding to the time in the next time zone (S61). In other words, the display controller 760 references the manual time zone setting data 682, and moves the hour hand 3D and minute hand 3C clockwise to the positions indicating the time corresponding to the time zone information one time zone ahead of the currently set or selected time zone information. If the currently set or selected time zone is the first time zone (+14 hours), the hour hand 3D and minute hand 3C move clockwise to the positions indicating the time corresponding to the second time zone (−12 hours).

However, if in S13 the crown 6 is determined to turn left, the display controller 760 moves the hour hand 3D and minute hand 3C counterclockwise to the positions indicating the time corresponding to the next time zone (S62). In other words, the display controller 760 references the manual time zone setting data 682, and moves the hour hand 3D and minute hand 3C clockwise to the positions indicating the time corresponding to the time zone information one time zone behind the currently set or selected time zone information. If the currently set or selected time zone is the second time zone (−12 hours), the hour hand 3D and minute hand 3C move clockwise to the positions indicating the time corresponding to the time in the first time zone (+14 hours).

If in S61, S62 the crown 6 is turned multiple times in succession when moving the hour hand 3D and minute hand 3C, moving the minute hand 3C is often not necessary at the final time zone even if moving the minute hand 3C is necessary at a time zone before the final time zone. As a result, the display controller 760 preferably delays starting moving the minute hand 3C to avoid moving the minute hand 3C unnecessarily.

For example, when the user operates the crown 6 continuously, the interval between crown 6 rotation inputs is often within a specific time, and when the specific time since input of crown 6 rotation has past, operation of the crown 6 has often stopped. As a result, the display controller 760 moves the hour hand 3D in conjunction with input of crown 6 rotation, and moves the minute hand 3C when a specific time has past since the last input of crown 6 rotation.

In S15, the time zone setter 730 references the manual time zone setting data 682, and selects the time zone information corresponding to the time the hour hand 3D and minute hand 3C indicate after moving. Whether or not the crown 6 has returned to the 0 stop position is then determined in S17.

Correcting the Time Zone

An example of correcting the time zone in this embodiment is described next.

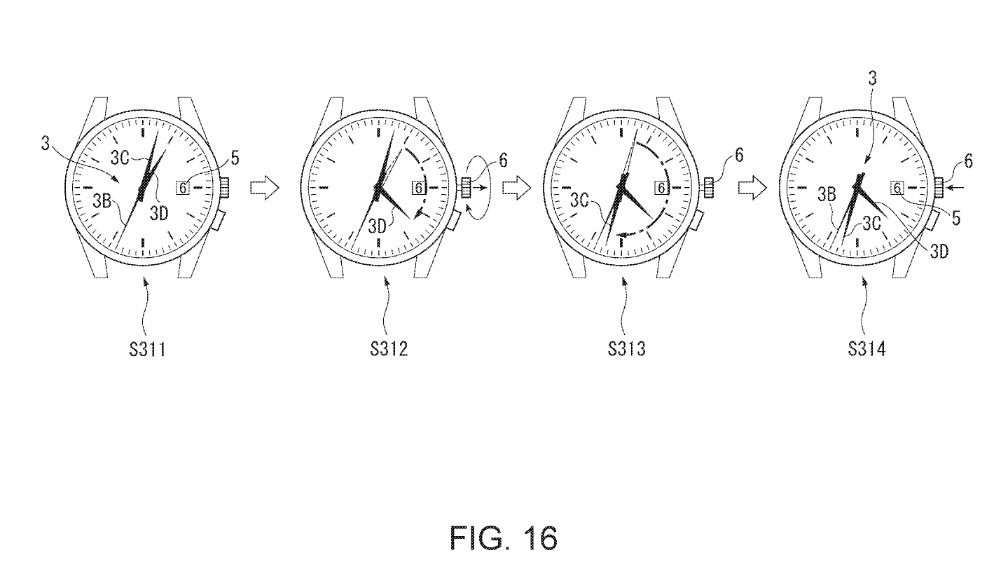

FIG. 16 shows an example in which the currently set time zone data 650 is +5.5 hours (Delhi), and as shown in S311 in FIG. 16, the displayed time changes from the 6th at 13:02 to the 6th at 16:32, and the time zone data is set to +9 hours (Tokyo).

In this example, as shown in S312, the crown 6 is pulled out to the first stop and turned seven times. As a result, the hour hand 3D moves clockwise to the position indicating the time corresponding to time zone information of +9 hours (the 6th at 16:32). In this case, as described above, because the minute hand 3C moves after a specific time has past since crown 6 input ends, only the hour hand 3D moves first, and then the hour hand 3D and minute hand 3C moves as shown in S313. Note that the minute hand 3C may start moving after the hour hand 3D stops.

As shown in S314, when the crown 6 returns to the 0 stop position, +9 hours is set as the time zone data 650, and the internal time information plus +9 hours (the 6th at 16:32) is indicated by the hands 3 and date wheel 5.

Effect of Embodiment 3

This embodiment has the same effect as the embodiments described above.

In addition, this embodiment enables using the crown 6 to move the hour hand 3D and minute hand 3C directly, and can adjust the time zone data 650 that is set based on the time zone data corresponding to the time displayed after moving the hour hand 3D and minute hand 3C. As a result, if the user knows the local time or the time difference in the current location, the user can easily change the time zone data 650 by directly moving the hour hand 3D and minute hand 3C even without knowing the time zone of the current location.

Furthermore, unnecessary movement of the minute hand 3C when moving the hour hand 3D and minute hand 3C can be suppressed because starting movement of the minute hand 3C is delayed relative to when the hour hand 3D starts to move.

### Other Embodiments

The invention is not limited to the embodiments described above, and can be modified and improved in many ways without departing from the scope of the accompanying claims.

When selecting time zone information by turning the crown 6 right and moving the hour hand 3D clockwise in the time zone setting process of the first and second embodiments described above, if the currently set or selected time zone information is at the maximum difference of +14 hours ahead of UTC (is the first time zone), further right rotation of the crown 6 does not cause the hour hand 3D to move, and time zone information is not selected, but the invention is not so limited. For example, further right rotation of the crown 6 could cause the hour hand 3D to move so that the time zone information (second time zone) of the maximum −12 hours behind UTC is selected.

When selecting time zone information by turning the crown 6 left and moving the hour hand 3D counterclockwise in the time zone setting process of the first and second embodiments described above, if the currently set or selected time zone information is at the maximum difference of −12 hours behind UTC (is the second time zone), further left rotation of the crown 6 does not cause the hour hand 3D to move, and time zone information is not selected, but the invention is not so limited. For example, further left rotation of the crown 6 could cause the hour hand 3D to move so that the time zone information (first time zone) of the maximum +14 hours ahead of UTC is selected.

When selecting time zone information by turning the crown 6 right in the time zone setting process of the third embodiment described above, the second time zone is selected if the currently set or selected time zone information is the first time zone, but the invention is not so limited. For example, as in the first and second embodiments, a time zone could be not selected.

Likewise, when selecting time zone information by turning the crown 6 left in the time zone setting process of the third embodiment described above, the first time zone is selected if the currently set or selected time zone information is the second time zone, but the invention is not so limited. For example, as in the first and second embodiments, a time zone could be not selected.

The time zone setting process in each of the foregoing embodiments may also include a jump function that changes the time zone information by adding or subtracting 12 hours from the currently set time zone information by pushing the button 7 without moving the hour hand 3D.

For example, the electronic timepiece may have a first jump function that selects the time zone information +12 hours ahead of the currently set time zone without moving the hour hand 3D when the button 7 is pushed for greater than or equal to 3 seconds and less than 6 seconds, and a second jump function that selects the time zone information −12 hours behind the currently set time zone without moving the hour hand 3D when the button 7 is pushed for greater than or equal to 6 seconds.

When time zone information is selected in the time zone setting process of the third embodiment, the hour hand 3D moves first and the minute hand 3C moves after a specific time has past after rotational input from the crown 6 ends, but the invention is not so limited.

For example, the hour hand 3D may move first in conjunction with input from the crown 6, and the minute hand 3C may move once movement of the hour hand 3D stops. The hour hand 3D may move first in conjunction with input from the crown 6, and the minute hand 3C may start moving a specific time after the hour hand 3D starts moving.

Further alternatively, the hour hand 3D and minute hand 3C may move simultaneously.

In this case, the minute hand 3C may always move simultaneously with the hour hand 3D, as when the hour hand and minute hand are driven by a single motor, or the minute hand 3C may move simultaneously with the hour hand 3D only when movement of the minute hand 3C is necessary.

For example, only the hour hand 3D moves if moving the minute hand 3C is not necessary at the time of the next time zone selected by turning the crown 6, but if moving the minute hand 3C is necessary, the hour hand 3D and minute hand 3C may move simultaneously.

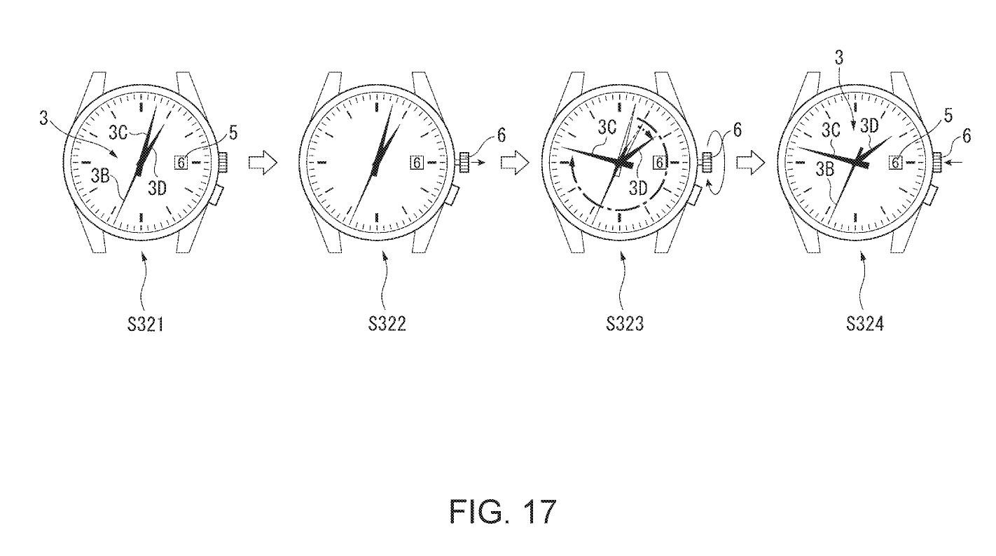

In the example in FIG. 17, supposed, as shown in S321 in FIG. 17, the currently set time zone data 650 is +5 hours (Karachi) and the displayed time is the 6th at 13:02, and the time zone data is changed to +5.75 hours (Katmandu) with a displayed time of the 6th at 13:47.

In this event, as shown in S322, the crown 6 is pulled out to the first stop. Next, as shown in S323, the crown 6 is turned twice to the right. As a result, time zone information of +5.75 hours is selected, and the hour hand 3D and minute hand 3C move simultaneously clockwise to the position indicating the time of the internal time information +5.75 hours (the 6th at 13:47).

As shown in S324, by pushing the crown 6 in to the 0 stop position, the time zone data 650 is set to +5.75 hours, and the hands 3 and date wheel 5 display the internal time information plus 5.75 hours (the 6th at 13:47).

During the time zone setting process in the embodiments described above, the display controller 760 may also cause the 54 to indicate morning or afternoon according to the time reflecting the selected time zone information.

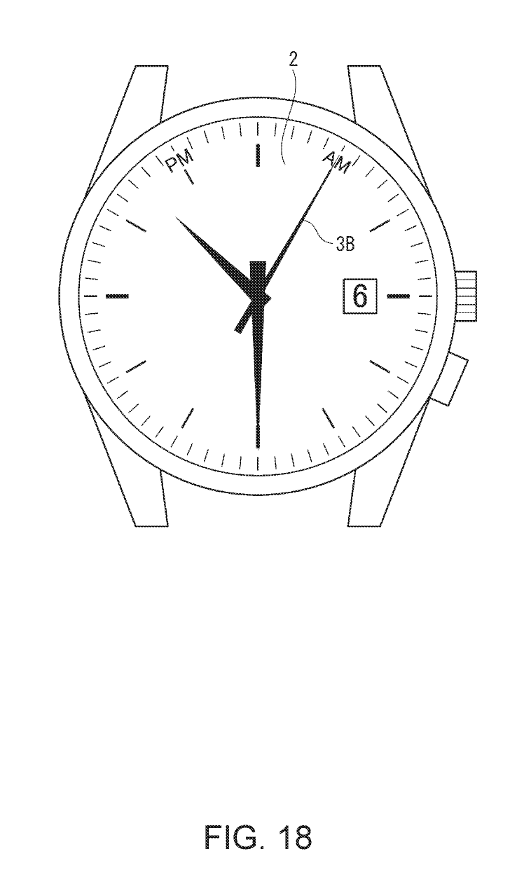

As shown in FIG. 18, for example, the letters AM denoting morning, and PM denoting afternoon, may be displayed on the dial 2. During the time zone setting process, the display controller 760 then sets the second hand 3B to AM or PM according to the time reflecting the selected time zone information.

Indicating AM or PM may be done as described below.

The display controller 760 controls the date wheel 5 to indicate morning or afternoon according to the position of the date wheel 5. More specifically, if morning (AM), the display controller 760 moves the space between the date numbers on the date wheel 5 (for example, to indicate the morning of the first, the space between 31 and 1) to the center of the date window 2B, and if afternoon (PM), moves the date number (for example, to indicate the afternoon of the first, the 1) on the date wheel 5 to the center of the date window 2B.

The display controller 760 may also morning or afternoon according to the position of the date wheel 5 by moving the position on the date wheel 5 in conjunction with the position of the hour hand 3D. For example, if the date is the first, moving the date wheel 5 so that the center of the 1 is in the window 2B at 12:00, the space between 31 and 1 moves into the window 2B at 00:00, and the space between the 1 and 2 is in the window 2B at 24:00 in conjunction with movement of the hour hand 3D. In this way, the user knows it is morning if the date wheel 5 turns clockwise (the direction in which the date reverses) relative to the center of the numbers on the date wheel 5, and knows it is afternoon if the date wheel 5 turns counterclockwise (the direction in which the date advances) relative to the center of the numbers on the date wheel 5.

Daylight saving time can also be set in response to operation of the input device 53 in the foregoing embodiments.

In other words, if the crown 6 is pulled out to the second stop in the daylight saving time setting operation, the controller 70 may indicate the current DST setting with the second hand 3B. If the DST setting is indicated and the button 7 is pushed, for example, in an operation changing the DST setting, the controller 70 changes the DST setting to on (DST is enabled) or off (DST is not enabled). When the DST mode is turned on and the crown 6 is returned to the 0 stop position, the time corrector 750 adds daylight saving time to the display time data 640. As a result, the time reflecting daylight saving time is displayed. If the DST mode is turned off and the crown 6 is returned to the 0 stop position, the time corrector 750 does not add daylight saving time to the display time data 640. As a result, standard time not reflecting daylight saving time is displayed.

The time added for daylight saving time may be a fixed amount (such as +1 hour), or the DST corresponding to the currently set time zone information in the manual time zone setting data 682.

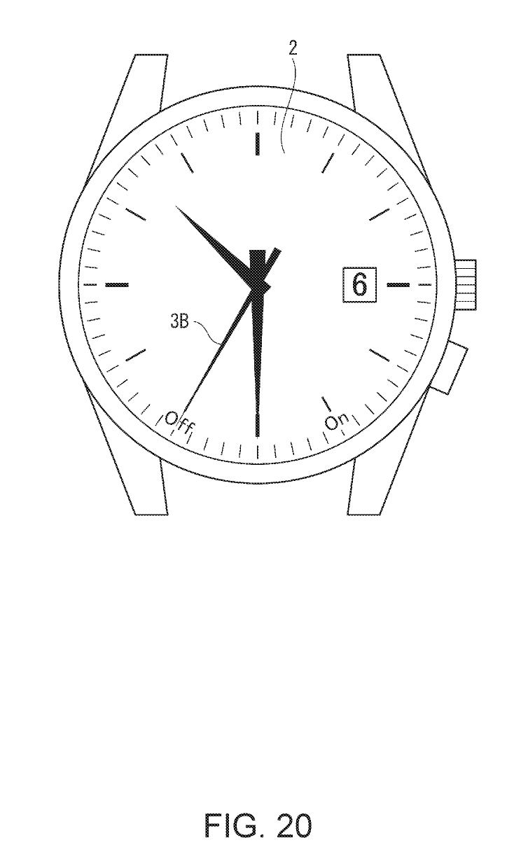

More specifically, as shown in FIG. 20, the words ON and OFF may be displayed on the dial 2, the display controller 760 sets the second hand 3B to the ON position when DST is enabled, and sets the second hand 3B to the OFF position when DST is turned off.

When the hour hand 3D is moved in conjunction with rotation of the crown 6 in the time zone setting process in the first and second embodiments described above, the hour hand 3D goes to the hour position, but the invention is not so limited. For example, the hour hand 3D may go to the position corresponding to the adjusted time, that is, to the position corresponding to the position of the minute hand 3C. For example, if the minute hand 3C is a the 30-minute position, the hour hand 3D goes to the position half-way between one hour position and the next hour position.

In addition to a time zone correction mode, the embodiments described above may also have a time zone confirmation mode for checking the currently set time zone. The time zone confirmation mode is executed by a specific operation of the operating means. In the time zone confirmation mode, the controller references the position indicated by the second hand 3B based on the manual time zone setting data 682, for example, and moves the second hand 3B to the position corresponding to the currently set time zone information.

In this case, if the user knows the relationship between time zone information and the position of the second hand 3B by reading the user manual, for example, the user can know the currently set time zone by reading the position of the second hand 3B.

The foregoing embodiments describe an electronic timepiece that calculates and acquires time zone information by receiving satellite signals, but the invention is not so limited. For example, time zone information may be received by means of Bluetooth® or other near-field communication method.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2017-013531, filed Jan. 27, 2017 is expressly incorporated by reference herein.

What is claimed is:

1. An electronic timepiece comprising:
an operating means;
memory configured to store information related to multiple time zone data indicating a time difference to a reference time, and information related to the set time zone data selected from the multiple time zone data;
a time display unit having at least an hour hand and a minute hand, and configured to display time; and
a controller configured to execute a time zone correction mode to correct the information related to the time zone data that is set;
the controller moving the hour hand and displaying time on the time display unit in response to operation of the operating means in the time zone correction mode, and
based on time zone data corresponding to the displayed time, correcting information related to the set time zone data.

2. An electronic timepiece comprising:
an operating means;
memory configured to store information related to multiple time zone data indicating a time difference to a reference time, and information related to the set time zone data selected from the multiple time zone data;
a time display unit having at least an hour hand and a minute hand, and configured to display time; and
a controller configured to execute a time zone correction mode to correct the information related to the time zone data that is set;
in the time zone correction mode, the controller is configured to select and execute an hour hand setting mode that moves the hour hand, and a minute hand setting mode that moves the minute hand;
move the hour hand and display time on the time display unit in response to operation of the operating means in the hour hand setting mode,
move the minute hand and display time on the time display unit in response to operation of the operating means in the minute hand setting mode, and
based on time zone data corresponding to the displayed time, correct information related to the set time zone data.

3. An electronic timepiece comprising:
an operating means;
memory configured to store information related to multiple time zone data indicating a time difference to a reference time, and
information related to the set time zone data selected from the multiple time zone data;
a time display unit having at least an hour hand and a minute hand, and configured to display time; and
a controller configured to execute a time zone correction mode to correct the information related to the time zone data that is set;
in response to operation of the operating means in the time zone correction mode, the controller moving the hour hand and the minute hand, and displaying time on the time display unit, and
based on time zone data corresponding to the displayed time, correcting information related to the set time zone data.

4. The electronic timepiece described in claim 2, wherein:
in response to operation of the operating means in the minute hand setting mode, the controller moving the minute hand to a position that can be set based on time zone data that can be selected according to the position of the hour hand.

5. The electronic timepiece described in claim 3, wherein:
in response to operation of the operating means, the controller moving the hour hand to a position that can be set based on the multiple time zone data; and
a specific time after operation of the operating means, moving the minute hand to a position that can be set based on the multiple time zone data.

6. The electronic timepiece described in claim 1, further comprising:
an hour hand motor that drives the hour hand; and
a minute hand motor that drives the minute hand.

7. The electronic timepiece described in claim 1, further comprising:
a receiver configured to radio signals;
the controller correcting information related to the time zone data based on the received radio signals.

8. The electronic timepiece described in claim 1, wherein:
when the time zone with the greatest difference ahead of Coordinated Universal Time is a first time zone, and
the time zone with the greatest difference behind Coordinated Universal Time is a second time zone,
the controller continues displaying the time corresponding to the first time zone when the operation advancing the time is performed by operating the operating means after the time corresponding to the first time zone is displayed, and
the controller continues displaying the time corresponding to the second time zone when the operation reversing the time is performed by operating the operating means after the time corresponding to the second time zone is displayed.

9. The electronic timepiece described in claim 1, wherein:
when the time zone with the greatest difference ahead of Coordinated Universal Time is a first time zone, and
the time zone with the greatest difference behind Coordinated Universal Time is a second time zone,
the controller displays the time corresponding to the second time zone when the operation advancing the time is performed by operating the operating means after the time corresponding to the first time zone is displayed, and
the controller displays the time corresponding to the first time zone when the operation advancing the time is performed by operating the operating means after the time corresponding to the second time zone is displayed.

10. The electronic timepiece described in claim 1, wherein:
the controller also has a first jump function that changes the set time zone to +12 hours without moving the hour hand when a predetermined first jump operation is performed by the operating means; and
has a second jump function that changes the set time zone to −12 hours without moving the hour hand when a predetermined second jump operation is performed by the operating means.

11. The electronic timepiece described in claim 1, wherein:
the time display unit has a second hand; and
the controller indicates with the second hand whether the time indicated by the hour hand is ante meridiem or post meridiem while the displayed time is being corrected by the operating means.

12. The electronic timepiece described in claim 1, wherein:
the time display unit has a date wheel; and
the controller indicates with the date wheel whether the time indicated by the hour hand is ante meridiem or post meridiem while the displayed time is being corrected by the operating means.

13. The electronic timepiece described in claim 1, wherein:
the time display unit has a second hand; and
the controller, when a display daylight saving time setting operation that displays the daylight saving time mode setting is performed by the operating means, indicates with the second hand whether the daylight saving time mode is on to display daylight saving time, or is off to not display daylight saving time; and
when the daylight saving time mode setting is displayed, and an operation changing the daylight saving time mode setting is performed by the operating means, changes the current state of the daylight saving time mode setting from off to on or on to off.
